(19) United States
(12) Patent Application Publication
(10) Pub. No.: US 2026/0096005 A1
(43) Pub. Date: Apr. 2, 2026

(54) PLASMA GENERATION SYSTEM WITH PLASMA GENERATOR HAVING SHORT ELECTRODE PROTRUSION AND/OR DISCONNECTABLE PORTION

(71) Applicant: Champion Aerospace LLC, Liberty, SC (US)

(72) Inventors: Artur P. Suckewer, Franklin Park, NJ (US); Brandon Woods, Liberty, SC (US)

(21) Appl. No.: 19/344,508

(22) Filed: Sep. 29, 2025

Related U.S. Application Data
(60) Provisional application No. 63/700,540, filed on Sep. 27, 2024.
(60) Provisional application No. 63/781,348, filed on Mar. 31, 2025.

(51) Int. Cl. H05H 1/48

(52) U.S. Cl. CPC H05H 1/48

(57) ABSTRACT

A plasma generation system includes a plasma generator such as an igniter and circuitry configured to apply a breakdown voltage across electrodes of the plasma generator to thereby form a plasma in an initiation region between the electrodes and then sustain and propagate the plasma outwardly for purposes such as combustion of a fuel. Various electrode configurations may be utilized that, along with plasma generating circuitry, enable the formation of virtual electrodes extending from the distal ends of the electrodes, resulting in a projection of plasma well beyond the physical electrodes. Such plasma generators may be used in various aerospace applications where only a short service life of the plasma generator is needed. Included are various techniques and components for enabling disconnection of the plasma generator from the system following ignition.

### TECHNICAL FIELD

The present disclosure relates generally to plasma generation as may be implemented in an ignition system and, more particularly, to traveling spark ignition (TSI) circuits and igniters for use in aerospace (aviation or space) applications, but not limited thereto.

### BACKGROUND

A conventional ignition system (e.g., in an internal combustion engine) applies stored energy to electrodes of an igniter to cause breakdown between the electrodes, forming a substantially stationary plasma between the electrodes and proximate an air-fuel mixture to effect (e.g., ignite) the mixture. The energy used to achieve breakdown and form the stationary plasma is typically stored in an inductor or a capacitor, and all of the stored energy is discharged into the igniter during each ignition cycle. The inductor or capacitor is then refilled with electrical energy in between discharge events. In a conventional automotive ignition system, an ignition coil stores energy that is provided to multiple spark plugs over respective ignition cycles using a distributor. The ignition coil is fully discharged into a given spark plug while that spark plug is connected to the distributor and then the ignition coil is recharged before the distributor connects to another spark plug.

A traveling spark igniter was previously developed for use in internal combustion engines. Traveling spark igniters generate a plasma kernel by applying a sufficiently high voltage between electrodes of the igniter to cause breakdown between the electrodes, at which point plasma is formed at the location of breakdown and is then propagated along the electrodes. Propagation is caused by Lorentz and thermal forces due to discharge current flowing between the electrodes through the plasma and interacting with a field created, at least in part, by current flowing in the electrodes.

More recently, traveling spark igniters have been developed that apply one or more follow-on pulses of current to the electrodes following breakdown and prior to total recombination of the plasma. The follow-on pulses are used to generate corresponding pulses of Lorentz force and thermal forces to grow and propagate the formed plasma along the electrodes. U.S. Pat. Nos. 11,419,204 and 11,715,935, assigned to the applicant of this present application, describe plasma generation circuitry and plasma generators that operate in this manner.

While an advantage of TSI is extending longevity in using the plasma generator as a long lived igniter for generation large ignition plumes, longevity is not always a priority. In some cases, it is desired to design for other benefits such as having low structural flow disturbance while projecting the energy from the plasma generation location.

An example is as an alternative to a pyrotechnic ignition (electro-chemical ignition). Pyrotechnic ignition is traditionally a one-time use ignition source that delivers substantial energy with volume, distance, and ionization. However, it is typically implemented as a ‘one shot’ approach. This becomes a limiting factor in its use in more complex modern devices, such that more recent pyrotechnic ignition has had to grow in power, complexity and mass. The units needed to have an extreme reliability when called upon in both effectiveness and stability over time.

### SUMMARY

According to an aspect of the present disclosure, a plasma generation system is provided, the system comprising:
a plasma generator, comprising:
   at least two electrodes each having a first end and a second end opposite the first end, the at least two electrodes extending nearly parallel to one another over a length from their first ends to their second ends; and
   an isolator spacing apart the at least two electrodes; and
circuitry configured to:
   apply across the at least two electrodes, a breakdown voltage sufficient to induce breakdown between the at least two electrodes, resulting in formation of plasma in an initiation region that is along the length of the at least two electrodes; and
   apply, across the at least two electrodes, at least one subsequent pulse of electrical energy sufficient to propagate the plasma from the initiation region towards the first ends of the at least two electrodes,
wherein a first electrode of the at least two electrode extends out of the isolator for a distance of no more than three times the edge-to-edge distance at the initiation region between the first electrode and a second electrode of the at least two electrodes; and
wherein the at least two electrodes are configured below the initiation region for a distance equal to or greater than the edge-to-edge distance at the initiation region such that current from the at least one subsequent pulse of electrical energy flowing through the electrodes below the initiation region produces a Lorentz force acting upon the plasma.

Various embodiments of the plasma generation system may include any one or more of the following features either alone or in any technically-feasible combination.
the first electrode extends out of the isolator for a distance of no more than two times the edge-to-edge distance.
the first electrode extends out of the isolator for a distance of no more than the edge-to-edge distance.
the first electrode extends out of the isolator for a distance of less than 0.08 inches.
the first electrode extends out of the isolator for a distance of less than 0.04 inches.
the first end of the first electrode is flush with the isolator within a tolerance of +/−0.01 inches.
at least one of the at least one subsequent pulse of electrical energy provides a current to the plasma generator of more than 450 Amps.
at least one of the at least one subsequent pulse of electrical energy provides a current to the plasma generator of more than 600 Amps.
at least one of the at least one subsequent pulse of electrical energy provides a current to the plasma generator of more than 1000 Amps.
the at least two electrodes extend substantially parallel to one another over a length from their first ends to their second ends.
the initiation region comprises a portion of the isolator.

In accordance with another aspect of the present disclosure, a plasma generation system is provided, the system comprising:
a plasma generator, comprising:
   first and second electrodes each extending for a length from an exposed distal end to a proximal end, each of the first and second electrodes extending along an electrode axis that is nearly parallel to the electrode axis of the other electrode for a length from the distal end towards the proximal end of the electrode; and
   an isolator spacing the electrodes apart; and
circuitry configured to:
   apply across the first and second electrodes, a breakdown voltage sufficient to induce breakdown between the electrodes, resulting in formation of plasma in an initiation region that is along the length of the electrodes; and
   apply, across the electrodes, at least one subsequent pulse of electrical energy sufficient to propagate the plasma from the initiation region in a direction away from the isolator,
wherein the at least one subsequent pulse of electrical energy includes a current flow through the electrodes sufficient to move the plasma to the distal ends and subsequently beyond the distal ends of the electrodes and to form virtual electrodes comprising electrical current flowing out of the distal end of one of the electrodes and through a portion of the plasma in a direction substantially parallel to the one electrode's axis and flowing into the distal end of an other of the electrodes through another portion of the plasma in a direction substantially parallel to the other electrode's axis, with a portion of the plasma extending between the virtual electrodes for conduction of the current from one virtual electrode to the other virtual electrode.

Various embodiments of the plasma generation system of the preceding paragraph may include any one or more of the following features either alone or in any technically-feasible combination.
the first electrode extends out of the isolator for a distance of less than 0.08 inches.
the first electrode extends out of the isolator for a distance of less than 0.04 inches.
the first end of the first electrode is flush with the isolator within a tolerance of +/−0.01 inches.
the current flow is more than 450 Amps.
the current flow is more than 600 Amps.
the current flow is more than 1000 Amps.
the electrode axes of the first and second electrodes are substantially parallel.
the circuit is configured to supply the current flow at an amperage and length of time such that the virtual electrodes extend beyond the distal ends of the electrodes by a length sufficient to create a Lorentz force from the current flowing through the virtual electrodes.
the Lorentz force from the current flowing through the virtual electrodes is sufficient to move outwardly away from the distal ends the portion of the plasma extending between the virtual electrodes.

In accordance with another aspect of the present disclosure, there is provided a method of creating a traveling spark, comprising:
forming a plasma from an ionizable medium by causing electrons to flow between a pair of spaced electrodes in the presence of the ionizable medium, wherein the electrodes each extend along an axis nearly parallel to each other, wherein the plasma is formed in a plasma initiation region between the electrodes, and wherein, at formation of the plasma, the electrons are emitted by one of the electrodes and received by the other of the electrodes in a direction substantially perpendicular to the electrode axes;
moving the plasma along the electrodes to distal tips of the electrodes by applying at least one subsequent current pulse to the electrodes before recombination of the plasma; and
moving the plasma beyond the distal tips using virtual electrodes that extend axially past the distal tips of the electrodes, wherein the virtual electrodes comprise electrons flowing out of the distal tip of one of the electrodes in a direction nearly parallel to the electrode's axis, through the plasma between the virtual electrodes, and into the other electrode in a direction nearly parallel to the other electrode's axis.

Various embodiments of the method may include any one or more of the following features either alone or in any technically-feasible combination.
the electrodes'axes are substantially parallel to each other.
the electrodes'axes are within 5° of being parallel to each other.

In accordance with yet another aspect of the present disclosure, there is provided a plasma generation system comprising plasma generating circuitry and a plasma generator, wherein the circuitry is configured to produce repeated pulses of plasma via the plasma generator, and wherein at least one portion of the plasma generation system can be automatically physically separated from one or more other portions of the plasma generation system, wherein the at least one portion includes the plasma generator or a portion thereof, and wherein the separation prevents the generation of subsequent pulses of plasma from the plasma generator.

Various embodiments of the plasma generation system of the preceding paragraph may include any one or more of the following features either alone or in any technically-feasible combination.
the at least one portion comprises the plasma generator.
the plasma generator comprises an igniter having a housing, first and second electrodes, and an isolator, wherein the electrodes and isolator are mounted in the housing with the electrodes being electrically isolated from one another by the isolator, wherein the housing has a circular perimeter portion comprising threads for mounting the igniter at a combustion chamber so that the electrodes are exposed to a reaction environment within the chamber.
the igniter has a central axis defining an axial direction and wherein the igniter has an axial length in the axial direction that is no more than two inches.
the axial length is no more than one inch.
the first and second electrodes have a length in the axial direction sufficient to generate a Lorentz force that moves a plasma formed between the electrodes outwardly from distal ends of the electrodes.
the length of the electrodes is sufficient to move the plasma with a current through the electrodes and plasma of at least 450 Amps.
the length of the electrodes is sufficient to move the plasma with a current through the electrodes and plasma of at least 600 Amps.
the length of the electrodes is sufficient to move the plasma with a current through the electrodes and plasma of at least 1000 Amps.
the plasma generator comprises an igniter having a housing, first and second electrodes, and an isolator, wherein the electrodes and isolator are mounted in the housing with the electrodes being electrically isolated from one another by the isolator, wherein the igniter includes a firing end having the first and second electrodes exposed for generating a plasma between the electrodes, the igniter further including a connecting end for connection to an ignition lead, wherein the isolator extends through the igniter and terminates at the connecting end with a ribbed insulator surface extending between the first and second electrodes to thereby define a surface path over the ribbed surface that is longer than the direct distance between the first and second electrodes.
the plasma generation system further comprises the ignition lead having a ribbed insulator and first and second conductors, wherein the ribbed insulator mates with the ribbed surface of the isolator when the ignition lead is connected to the igniter with the first and second electrodes electrically connected to the first and second conductors, respectively.
the plasma generator comprises circuitry configured to supply electrical pulses to the plasma generator sufficient to cause the plasma generator to form plasma, the circuitry being further configured to supply a plurality of the electrical pulses to the plasma generator;
   wherein the at least one portion of the plasma generation system is configured to be positioned at the sub-vehicle such that the plasma is formed in the presence of a depletable energy source that is ionizable or combustible by the plasma so as to generate thrust separating the sub-vehicle from the main vehicle; and
   wherein the one or more other portions of the plasma generation system are mountable in the main vehicle, whereby at least the one or more other portions of the plasma generation system remains with the main vehicle following the separating of the sub-vehicle from the main vehicle.

In accordance with another aspect of the present disclosure, there is provided yet another plasma generation system, comprising:
a plasma generator having a first electrode; and
circuitry configured to apply electrical energy between the first electrode and a second electrode that is sufficient to form plasma between the first and second electrodes;
wherein a first portion of the plasma generation system automatically disconnects from a remaining portion of the plasma generation system.

The plasma generation system of the preceding paragraph may further comprise the second electrode, a housing, and an isolator, wherein the first and second electrodes and isolator are mounted in the housing with the isolator electrically isolating the first and second electrodes, wherein the first portion comprises the plasma generator.

### BRIEF DESCRIPTION OF DRAWINGS

Preferred exemplary embodiments of the invention will hereinafter be described in conjunction with the appended drawings, wherein like designations denote like elements. The accompanying drawings are not intended to be drawn to scale. For purposes of clarity, not every component may be labeled in every drawing.

FIG. 1A illustrates an example plasma generation system including a cross-section of a plasma generator and circuitry configured to apply electrical energy across electrodes of the plasma generator.

FIG. 1B is an enlarged view of the firing end of the plasma generator shown in FIG. 1A.

FIG. 2 illustrates example circuitry that may be included in the plasma generation system of FIG. 1A.

FIG. 3A illustrates example application of follow-on current following breakdown in the plasma generation system of FIG. 1A.

FIG. 3B illustrates an alternative example application of follow-on current following breakdown in the plasma generation system of FIG. 1A.

FIG. 4 is a schematic of an example plasma generation system having two plasma generators, two channels of plasma generation circuitry, and shared circuitry that is used by both channels.

FIG. 5A illustrates a top view of an example plasma generator having an isolator spacing apart a plurality of electrodes that may be included in the plasma generation systems of FIGS. 1A and 4.

FIG. 5B illustrates a side view of a partial cross-section of the plasma generator of FIG. 5A.

FIG. 5C illustrates a side view of a partial cross-section of an alternative example plasma generator that may be included in the plasma generation systems of FIGS. 1A and 4.

FIG. 6A illustrates a side view of an example igniter that may be included as at least a portion of a plasma generator in the plasma generation systems of FIGS. 1A and 4.

FIG. 6B shows a top view of the igniter of FIG. 6A showing an inner electrode and a plurality of outer electrodes.

FIG. 6C is an enlarged view of the firing end of the igniter of FIG. 6A showing the internal connection of one of the outer ground electrodes.

FIG. 6D depicts an alternative firing end of the igniter of FIG. 6 having outer electrodes that are shorter than the inner electrode.

FIG. 7A diagrammatically depicts a relative electrode directionality that is substantially parallel;

FIGS. 7B and 7C diagrammatically depict different relative electrode angles that are nearly parallel.

FIGS. 8A-8C diagrammatically, respectively depict progression of a plasma from a plasma initiation region, to an electrode distal end position, and to a projected position via virtual electrodes.

FIGS. 9A-9C diagrammatically, respectfully depict sequential states of a plasma forming virtual electrodes from an initial plasma formation, to an initial virtual electrode formation, and to a fully projected plasma.

FIGS. 10A and 10B are diagrams depicting ignition-based separation of a sub-vehicle from a main vehicle with a portion of the plasma generation system that disconnects from the remaining parts of the system in either an axial or lateral disconnection direction, respectively.

FIGS. 11A and 11B diagrammatically depict the separation and connection, respectively, of the portions of the plasma generation system in FIG. 10A.

FIG. 11C diagrammatically depicts a configuration of electrodes and an insulator that allows for the lateral disconnection direction of FIG. 10B.

FIG. 12A is a perspective view of an igniter and ignition lead connector that are configured for automatic disconnection.

FIG. 12B is a view as in FIG. 12A showing the igniter fully seated in the connector;

FIG. 12C is a vertical plane cross-section taken through the center of the igniter and connector of FIG. 12B.

FIG. 13A is a top perspective view of a zero protrusion traveling spark igniter shown mounted in a portion of a combustion chamber wall.

FIG. 13B is an enlarged, top perspective view of the igniter of FIG. 13A.

FIG. 13C is an enlarged, fragmentary, top perspective, cross-sectional view of the mated igniter and ignition lead connector taken along the 13 13 line of FIG. 13A.

FIG. 13D is an enlarged, cross-sectional view taken along the same 13-13 line of FIG. 13A.

FIG. 13E is a bottom perspective view of the igniter of FIG. 13A.

FIG. 13F is a top perspective view of the ignition lead connector shown in FIGS. 13C and 13D.

FIG. 13G is an enlarged, fragmentary, top perspective, cross-sectional view as in FIG. 13C, but showing the disconnection of the igniter and ignition lead connector.

FIG. 13H is an enlarged, cross-sectional view as in FIG. 13D, but showing an alternative ignition lead connector and an acute disconnection direction of the igniter from the connector.

FIG. 14A is a top perspective view of a spiral insulator that may be used in the various igniters and other plasma generators disclosed herein.

FIG. 14B is a top perspective view of a concentric insulator that may be used in the various igniters and other plasma generators disclosed herein.

FIG. 15A is a top perspective view of a non-TSI spark igniter that mounts in an aperture in a combustion chamber wall.

FIG. 15B is a cross-sectional view taken along the 15-15 line of FIG. 15A.

FIG. 15C is a cross-sectional view as in FIG. 15B showing the non-TSI spark igniter disconnecting from an ignition lead connector at an acute angle relative to the axial direction of the spark igniter.

FIG. 16A is a top perspective view of an upper portion of an ignition system component mated with a lower portion of an ignition system component.

FIG. 16B is a top perspective view showing the upper portion of FIG. 16A disconnecting from the lower portion in a lateral disconnection direction.

FIG. 16C is a top perspective view showing the upper portion of FIG. 16A lifted up from the lower portion in a partially lateral disconnection direction.

FIG. 16D is a top perspective, cross-sectional view taken along the 16D-16D line of FIG. 16A.

FIG. 16E is a top perspective, cross-sectional view taken along the 16E-16E line of FIG. 16A.

FIG. 17A is a top perspective view of a upper ignition system component mated with a lower ignition system component.

FIG. 17B is a top perspective, cross-sectional view taken along the 17-17 line of FIG. 17A.

FIG. 17C is a top perspective view of a two-part rectangular ignition system component having only one electrode.

### DETAILED DESCRIPTION

In many applications, preserving (or extending) the longevity of a plasma generation device is desirable. However, in some cases it is not a priority. An example is where physical layout of the design creates a flow disruption of the flow of the atmosphere that the plasma is being imparted to. If the priority is projecting plasma, this may still be achieved with an understanding that the penalty is electrode longevity.

This is achieved by moving the initiation region toward or even to the distal end of the plasma generator (igniter). This can be done by shortening the protrusion length of the electrodes compared to typical igniter designs. The absolute case is a structure where the distal end is completely flush and there is no disturbance. However, this induces a bit more compromise to the performance of the plasma generator. By minimizing the projection of the electrodes into the combustion chamber and using the detachable plasma generator, this aspect of the invention provides a low flow disturbance using a low retained mass plasma source.

Assuming some slight flow disturbance may be tolerated for the application, some electrode tip protrusion, or insulator recess is preferred. This allows for elimination of sharp edges or corners at the electrode distal tips. Which, in turn provide better plasma stability.

The reason this is possible has been discovered through experimentation. While it was understood that if the electrode rails were too short for a given discharge they would ablate/burn/vaporize at the distal tips, it was not known that with sufficient current and proper electrode configuration, the force imparted to the plasma would be sufficient to project it beyond the distal tips in a controlled manner. Based on experimental results there was only a slight compromise in plasma projection and performance when the electrodes were flush, or nearly so, with the insulator that formed the discharge initiation region. Without being limited to any specific theory of operation, it is believed that the reason for this is that the force projecting the plasma away is sufficiently strongly that the plasma itself can create a current path axially away from the electrode distal tips such that the plasma forms ‘virtual’ or ‘transient’ electrode extensions in the direction of the physical electrode axes, such that the discharge and plasma plume remain stable.

As the plasma projects and builds, the magnetic field forms around the current flowing through the plasma being projected and the standard calculation of forces may be applied with the added factor of slightly increasing resistance as the current path through the plasma lengthens with the increasing plasma projection.

This effect can occur with short protrusion electrodes because, at discharge initiation, the magnetic fields are well defined by the plasma generator's geometry at and below the initiation region. Preferably for some distance below the initiation region.

While the preferred electrode geometry is parallel smooth rod form electrodes, other geometries such as coaxial may be implemented, those skilled in the art will understand the tradeoffs of these designs.

In uses where good plasma generation function is important but repeated use is not, such as initial ignition of a device that does not need to re-light once lit, it may be desirable to separate the plasma generator from the rest of the plasma generation system once the plasma generator has accomplished its intended task.

Accordingly, the present disclosure provides plasma generators and associated techniques that are usable for combustion systems in which the plasma generators are used to form and/or continue a plasma that causes ionization and/or combustion of a fuel or other energy source in a reaction chamber with only minimal protrusion of the plasma generator into the chamber. In embodiments, this can be done using a plasma generator having at least two electrodes supported by and held within an isolator, with the electrodes having a total length that includes a first (exposed, firing) portion that extends out from a surface of the isolator, and a second (embedded, mounted) portion that extends from the surface down into the isolator. Advantageously, the lengths of the firing portion and mounting portions are selected so as to 1) maintain a relatively short protrusion of the electrodes beyond the end of the isolator that is suitable for a particular application of the plasma generator and 2) extend a relatively longer distance within the isolator sufficient to create a Lorentz force that moves the plasma outwardly away from the isolator along the protruding length of the electrodes.

The present disclosure also provides plasma generators and associated techniques that can be used in applications in which good plasma generation and/or projection is needed or desired, but repeated use is not a priority over other aspects such as flow disturbance through a combustion chamber. For example, at least some embodiments of the disclosed plasma generation systems can produce traveling spark ignition (TSI) which can replace one-time pyrotechnic ignition that only fires once and does not require re-light once lit. By projecting its energy, TSI can compete with a pyrotechnic ignition since it supplies energy at a distance from the source—the energy that often most impacts ignition capability in applications where pyrotechnic ignition is used. And, advantageously, TSI allows for multiple ignition attempts which provides reliability and allows for the use of a simpler electric ignition source relative to some of the complex pyrotechnic ignition systems in use.

In addition to being able to fire the ignition more than once, many of the igniter designs described herein allow for minimal to zero protrusion into the combustion environment so as to reduce or eliminate flow disturbance by the igniter. As even dozens or hundreds of discharges are superior to a single discharge, significant electrode ablation per-discharge is inconsequential. Thus, there is not a need in such applications for the longer electrode protrusions that may be required for TSI spark plugs or igniters to allow the plasma to move along the electrodes so as to not overheat or otherwise ablate the electrode. Rather, the disclosed igniters provide a design that trades igniter longevity for significant plasma projection and minimal flow interference. By use of suitable magnitude and pulse length of current, the electrode rails become ‘virtual’ in that the plasma itself, when being projected, forms an extended current path beyond the electrode tips that generates the electromagnetic field used to project the plasma farther from the electrodes.

A common aerospace application of this is for stage separation of a sub-vehicle from a main vehicle during flight. Where the sub-vehicle includes a solid fuel or other energy source that, once ionized or ignited, needs no re-light, the ignition system may be carried by the main vehicle with a portion of the ignition system being positioned at or mounted to the sub-vehicle. Then, following ignition, the portion may disconnect from the remainder of the ignition system such that the majority of the ignition system remains with the main vehicle. In this way, a multiple discharge capable system can carry lower mass on the sub-vehicle, post ignition, when compared to a robust pyrotechnic igniter-based system.

Particular embodiments of this disconnectability are described below and shown in the drawings. In general, his can be done by providing a plasma generator having electrodes and plasma generating circuitry that creates a plasma used for initiating combustion of a solid fuel on the sub-vehicle and that, once initiated, allows a portion of the plasma generating system to detach. To provide this separation functionality, the circuitry of the plasma generation system can be located on the main vehicle with only the igniter or other plasma generator being positioned at the sub-vehicle so as to ignite its fuel source. Upon ignition and initial separation of the sub-vehicle from the main vehicle, the plasma generator can automatically disconnect from the ignition lead and travel with the sub-vehicle, without the need for the entire plasma generator and plasma generator circuitry having to be carried by the sub-vehicle. In some embodiments, the entire ignition system, including the igniter can be configured to stay with the main vehicle. In other embodiments, the igniter, or a portion thereof, may be mounted on the sub-vehicle with a disconnection feature that allows the igniter, or portion thereof, to disconnect from the rest of the ignition system and continue with the sub-vehicle. The disconnection feature can be configured such that the force needed to disconnect the igniter or igniter portion from the remaining portions of the ignition system comes from the thrust produced by the engine activated by the plasma generator's discharge.

It will be appreciated that aspects of the present disclosure may be used individually or in combination as the present disclosure is not so limited. Thus, for example, in some embodiments, the plasma generator may include at least two electrodes having the flush or small protrusions described herein, as well as having the two disconnectable plasma generator or other portions of the system that are also described herein.

As used herein and including in the claims, the following terms have the meanings ascribed or scope ascribed.

References to electrodes, surfaces, axes or other components or features being “substantially”parallel means that they are parallel within 15° of each other.

References to electrodes, surfaces, axes or other components or features being “nearly” parallel means that they are parallel within 35° of each other. “Plasma generator” means a physical device capable of generating a plasma whether as a momentary spark or as a sustained arc.

An “igniter” is a type of plasma generator used to create a chemical reaction or other reaction (such as ionization) of an energy source such as propellants, including jet fuel, solid fuel, ion drive and thruster propellants such as noble gases and PTFE, as well as anything else that can be used to develop thrust as a result of being exposed to the plasma. “Igniter” and “plasma generator” may be used herein interchangeably, it being understood that an igniter is a specific instantiation of a plasma generator.

A “physical” electrode refers to a tangible component made of an electrically-conductive material such as a metal or metal alloy. References to electrodes herein refer to physical electrodes except where such electrodes are specifically called out as “virtual” electrodes or where the context otherwise indicates that such electrodes are “virtual” electrodes.

A “virtual” electrode refers to a portion of electrical current flowing through a plasma in a direction that is nearly parallel to an axial direction of a physical electrode from which or into which the portion of electrical current flows.

Isolator and insulator have the same meaning as will be known to those skilled in the art of igniters and other plasma generators.

For components that can be placed into a mating connection by bringing them together and placing them into contact with each other along a mating direction, references herein to components that “automatically” disconnect mean that the components are disconnected by a force or force component between them that is in a direction opposite the mating direction, without the use of force applied by a human or robotic means to the components. Components and approaches for such automatic disconnection include friction (slip) fits, magnets, clips, and other interconnections imparting a friction force rather than a positive interlock. “Reaction environment” means an open or closed environment that includes an energy source that can be utilized in a chemical reaction or by ionization to convert the energy source into another product or state.

### Plasma Generation System

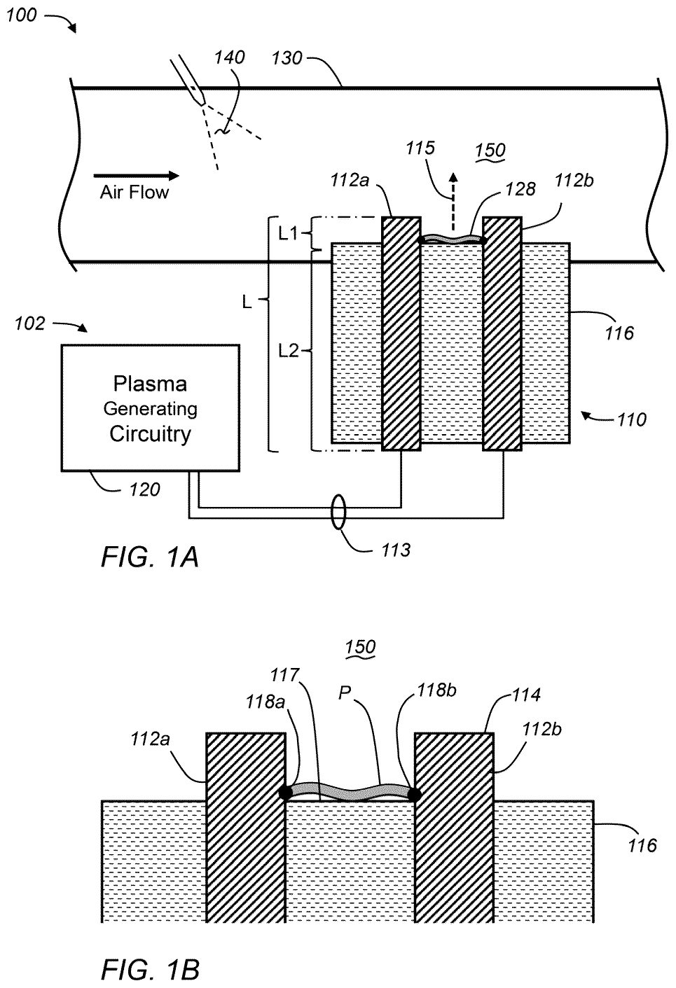

Turning to the figures, FIG. 1A illustrates an example combustion system 100 including a plasma generation system 102 having a plasma generator in the form of an igniter 110 and circuitry 120 in the form of an exciter configured to apply electrical energy across electrodes 112a, 112b of the plasma generator 110 via an ignition lead 113, thereby forming a plasma 128 in a combustion chamber 130 of the combustion system 100, according to some embodiments. In FIG. 1A, one plasma generator 110 is shown included in the plasma generation system 102, though any number of plasma generators may be included depending on the application.

In some embodiments, a plasma generator 110 may include the at least two electrodes 112a, 112b configured to form plasma between the electrodes 112a and 112b when a voltage sufficient to cause breakdown between electrodes 112a, 112b is applied thereto. For example, as shown in FIG. 1A, a first electrode 112a and a second electrode 112b may receive the breakdown voltage thereacross, such as by having the breakdown voltage applied to one electrode (e.g., 112a) and a reference voltage (e.g., ground) applied to the other electrode (e.g., 112b). For instance, the breakdown voltage may be sufficient that a dielectric (e.g., air gap or partial vacuum) between the electrodes 112a, 112b may break down and form plasma that provides a conductive path between the electrodes 112a, 112b through which current may flow.

In some embodiments, breakdown between the electrodes 112a, 112b may result in formation of plasma in an initiation region. For example, in FIG. 1B, a plasma kernel P is shown formed between the electrodes 112a, 112b between a respective first point 118a and respective second point 118b. For instance, the first point 118a and the second point 118b may form the initiation region with initial plasma formation therebetween. In some embodiments, the initiation region may be a region at which electrical discharge between the electrodes 112a, 112b through the broken-down dielectric begins, thereby providing a conductive path within that region through the plasma where the dielectric broke down. For example, the initiation region may be where, prior to breakdown (and/or prior to formation of plasma and/or prior to system-induced ionization), impedance is lowest between the electrodes 112a, 112b. In the illustrated embodiment, the electrodes 112a, 112b are separated by an isolator 116, which may include ceramic, such that a surface (e.g., top surface 117 in FIG. 1B) of the isolator 116 provides a lowest impedance path between the electrodes 112a, 112b. For instance, the initiation region may be proximate a surface of the isolator 116. In some embodiments, a surface (e.g., top surface 117 in FIG. 1B) of the isolator 116 may be treated (e.g., with a conductive agent that induces semiconductive behavior) to further reduce the impedance proximate the surface, as this may reduce the breakdown voltage needed to initiate plasma formation. In some embodiments that are configured to propagate plasma along a length of the electrodes 112a, 112b, such as described further below, an initiation region may be a first location from which the plasma is propagated (e.g., terminating at least at the distal tips of the electrodes).

It should be appreciated that multiple initiation regions may be present in a plasma generator as formed and/or configured for use. For example, where electrodes are manufactured with portions projecting towards one another, such portions may provide a lowest impedance path between the electrodes prior to at least some applications of the breakdown voltage. In the same example, portions projecting towards one another may be destroyed after several applications of the breakdown voltage such that other points along the electrodes have a lowest impedance path between the electrodes. Any or each of such points may be considered an initiation region in which the electrodes are configured to initially form plasma following application of a breakdown voltage, even before destruction of some portions that form an initiation region.

In some embodiments, a plasma generation system (e.g., 102) may be configured to apply to the electrodes 112a, 112b after applying the breakdown voltage and before total recombination of the plasma, follow-on electrical energy resulting in a follow-on current through the plasma. For example, following breakdown and without application of follow-on energy, the plasma may naturally recombine as time goes on, which results in a rapid reduction in the amount of current flowing through the plasma. In this example, follow-on current may flow through the plasma thereby sustaining the plasma and maintaining the conductive path therethrough. Moreover, as described further herein, the follow-on current may propagate the plasma along the electrodes 112a, 112b, such as by producing a Lorentz force component along the electrodes 112a, 112b.

In some embodiments, electrical energy applied to the electrodes 112a, 112b may be sufficient to propagate the plasma along a length of the electrodes 112a, 112b. For example, in a traveling spark igniter configuration, current flowing through the electrodes 112a, 112b may produce a Lorentz force component along a length of the electrodes 112a and/or 112b that pushes the plasma outwardly along the length of the electrodes 112a, 112b (e.g., along the length direction 115 indicated by the upward arrow). For instance, following application of a pulse of current, the plasma kernel P shown in FIG. 1B may move in the length direction 115 towards a distal tip 114 of the electrodes 112a, 112b. In some embodiments, applying a sequence of multiple pulses of follow-on current prior to total recombination of the plasma may sustain propagation of the plasma kernel P with each pulse beyond any initial propagation that may be caused by application of the breakdown voltage.

With sufficient current flowing through the electrodes and the formed plasma, a Lorentz force may result from the generated perpendicular electric and magnetic fields, causing the plasma to travel from the surface of the isolator to the distal ends of the electrodes. It should be appreciated that the amount of Lorentz force generated may depend on characteristics of the environment, the electrodes (e.g., materials thereof), the medium in which plasma is formed (e.g., isolator and/or dielectric gap), and the amount of applied electrical energy, and the speed of travel of the plasma can depend on the amount of Lorentz force generated.

In some embodiments, a plasma generation system (e.g., 102) may be further configured to apply, to the electrodes 112a, 112b, follow-on energy flowing through the plasma sufficient to propagate the plasma and then to further propagate the plasma. For example, the follow-on current (e.g., flowing between the first point 118a and the second point 118b) may include a first pulse of current and the second follow-on current may include a second pulse of current applied at a time later than the first pulse of current. For instance, the second follow-on current may flow through the plasma when it has traveled to a farther point on the electrodes, and that the plasma may be propagated using the follow-on pulses of current to propagate the plasma as far as, and even beyond, the distal tips 114 of the electrodes, the extent of propagation being limited based on available energy, thermal, and pressure conditions in the environment. For instance, high pressure and/or high temperature environments may limit the amount of electrical energy that may be usefully discharged (e.g., without vaporizing the electrodes) and achieve plasma propagation (e.g., against the high resistance to motion of a dense environment), whereas lower pressure environments may permit propagation of a few inches or more.

In some embodiments, plasma generation circuitry 120 such as shown in FIG. 1A may be configured to control application of electrical energy to electrodes of a plasma generator. For example, the plasma generation circuitry 120 shown in FIG. 1A may be configured to control application of electrical energy to the illustrated plasma generator 110, such as to apply pulses of electrical energy to the plasma generator 110. In some embodiments, the plasma generation circuitry 120 may include one or more switching elements configured to control application of electrical energy to the plasma generator.

In some embodiments, application of electrical energy to electrodes of a plasma generator may be controlled at least following breakdown in the plasma generator. For example, prior to the plasma generation circuitry 120 controlling application of electrical energy to a plasma generator 110, a breakdown voltage may have already been applied to the plasma generator 110 (e.g., using the same and/or different circuitry). For instance, the plasma generation circuitry 120 may be configured to control application of follow-on electrical energy to a plasma generator 110 following breakdown in the plasma generator 110. This is in contrast to conventional ignition systems in which, following breakdown, electrical energy is only applied to an igniter in an uncontrolled manner, such as with the electrical energy freely oscillating between a capacitor and an ignition coil to sustain the plasma formed at breakdown.

In some embodiments, electrical energy controllably applied to electrodes of a plasma generator 110 following breakdown may include a pulse of electrical energy sufficient to prevent total recombination of plasma formed between the electrodes 112a, 112b of the plasma generator 110 to which the electrical energy is applied, and/or sufficient to propagate the plasma formed between the electrodes 112a, 112b along the length of the electrodes 112a, 112b, and/or sufficient to move a point at which (e.g., to and/or from which) electrical energy is discharged from the electrodes 112a, 112b, and/or sufficient to produce a Lorentz force component along the electrodes, as described above.

In some embodiments, application of electrical energy to a plasma generator may be actively controlled following breakdown. For example, active control of electrical energy to a given plasma generator 110 following breakdown may include use of an active element (e.g., switching element and/or diode) to initiate, terminate, and/or adjust application of electrical energy at a time following breakdown. For instance, following breakdown, application of electrical energy may be actively initiated, terminated, and/or adjusted to achieve an actively controlled amount of electrical energy discharged from the electrodes through plasma between the electrodes 112a, 112b. In some cases, active control may further include a feedback loop sensing current flowing between the electrodes 112a, 112b through the plasma, but is not limited thereto.

In some embodiments, the plasma generator 110 may be disposed in an ignition environment in which it is desired to form and/or propagate plasma to ignite an air-fuel mixture. For example, at least distal tips 114 of the electrodes 112a, 112b may be disposed proximate to a reaction environment 150, though in other cases, more of the electrodes 112a, 112b may be exposed to the environment 150. In the illustrated example, the plasma generator 110 is exposed to the reaction environment 150 within the combustion chamber 130. In some embodiments, at least a portion of the plasma generator 110 may be positioned within the combustion chamber 130. For example, the entire plasma generator 110 may be positioned within the combustion chamber 130, or only a portion of the plasma generator 110 may be positioned within the combustion chamber 130. For instance, as shown in FIG. 1A, the distal tips 114 of the electrodes of the plasma generator 110 are positioned within the combustion chamber 130, while other portions of the electrodes 112a, 112b and the isolator 116 are not in the combustion chamber 130. In further embodiments, no portion of the electrodes 112a, 112b may be within the combustion chamber 130, such as where the plasma generator 110 may be positioned in a pre-chamber that is in communication with the combustion chamber 130. In some embodiments, the plasma generator 110 may be configured to direct and/or propagate plasma towards and/or into the combustion chamber 130. For example, plasma may extend and/or propagate to and/or beyond the distal tips 114 of the electrodes 112a, 112b such that plasma enters the combustion chamber 130.

In some embodiments, plasma formed from breakdown between the electrodes 112a, 112b may be exposed to an energy source 140 (e.g., fuel) positioned within the combustion chamber 130. For instance, plasma formed at the electrodes 112a, 112b may be proximate to the energy source 140 (e.g., closer to the energy source than to any other substance in the combustion chamber 130, except for air). For example, as shown in FIG. 1A, the plasma formed at electrode 112a and electrode 112b is exposed to the energy source 140 that is spread throughout the combustion chamber 130, though in other examples, the energy source 140 may be in only a portion of the combustion chamber 130. In this example, the plasma may then interact with the energy source 140 such that the energy source 140 ignites and releases thermal energy and/or other product. In some embodiments, the plasma may make direct contact with the energy source 140. In other embodiments, the plasma may be close enough to the energy source 140 that the plasma interacts with the energy source 140 to cause a chemical reaction. In some cases, the electrodes 112a, 112b of the plasma generator 110 may be exposed to the energy source 140, but the present disclosure is not limited thereto.

In some embodiments, the energy source 140 may be a combustible compound. For example, the energy source 140 may be a compound which capable of participating in a combustion reaction when exposed to sufficient energy (e.g., thermal energy, plasma). For instance, the energy source 140 may be one reactant in a combustion reaction that, when combined with oxygen (e.g., gaseous oxygen), the energy source 140 ignites (e.g., combusts) to produce one or more products. In some embodiments, the energy source 140 may be a fuel, such as a hydrocarbon. In some cases, the energy source 140 may be any of a variety of suitable fuels for combustion engines including gasoline, jet fuel, ethanol, and/or combinations thereof.

In some embodiments, when the plasma is exposed to the energy source 140 in the combustion chamber 130, the energy source 140 may undergo a chemical reaction, such as an exothermic reaction. For instance, the exothermic reaction may be a combustion reaction. For example, the plasma may interact with the energy source 140 such that the energy source 140 reacts with one or more components in the environment to produce (e.g., release) thermal and/or acoustic energy.

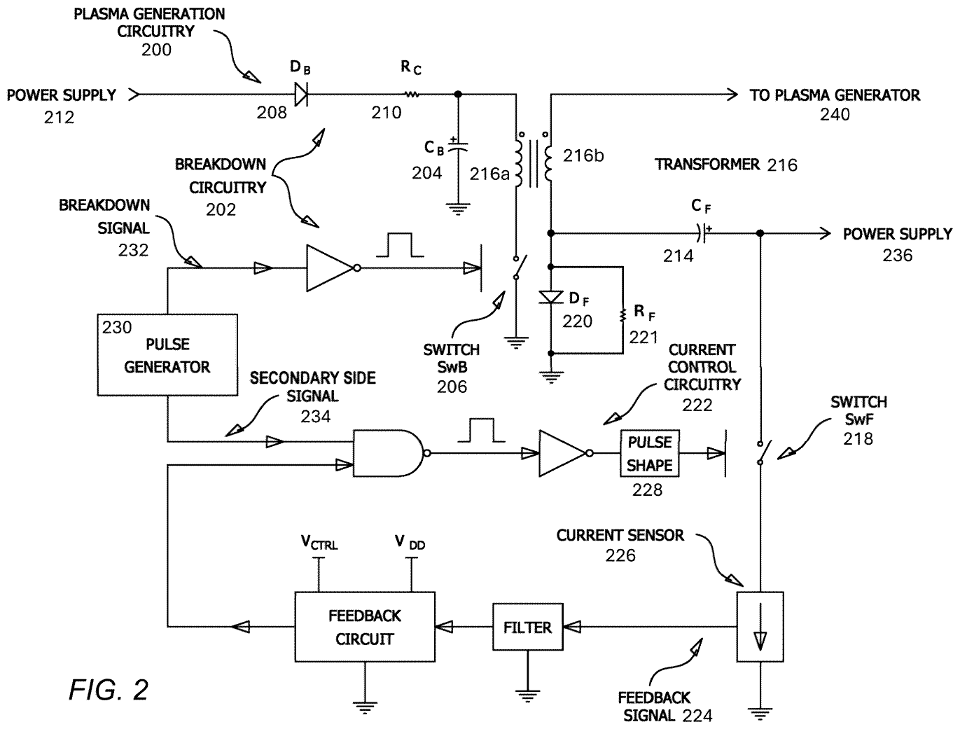

FIG. 2 illustrates example circuitry 200 that may be configured to apply a controlled pulse of electrical energy to a plasma generator that may be included in the plasma generation system of FIG. 1, according to some embodiments.

In FIG. 2, the plasma generation circuitry 200 includes breakdown circuitry 202, which may be configured to apply a breakdown voltage to electrodes (e.g., electrodes 112a and 112b of FIG. 1A) of a plasma generator 240 using energy stored in an energy storage device (e.g., other than the energy storage device used for applying follow-on energy but not limited thereto). For example, in FIG. 2, the breakdown circuitry 202 includes a breakdown capacitance 204 coupled to a breakdown switch 206 via a primary coil 216a of a transformer 216. For instance, upon closing of the breakdown switch 206, energy stored in the breakdown capacitance 204 may pass through the primary coil 216a and thereby draw current through a secondary coil 216b of the transformer 216 to the plasma generator, which may produce a voltage across the secondary coil 216b sufficient to cause breakdown (e.g., due to a turns ratio of the transformer and the rate at which current is changing at least in the secondary coil 216b). In the illustrated embodiment, a pulse generator 230 is further included to produce a breakdown signal 232 applied to the breakdown switch 206 to controllably initiate breakdown.

In the illustrated embodiment, breakdown capacitance 204 may be charged via a breakdown diode 208 and a charging resistor 210 from a power supply 212. For example, after breakdown, the breakdown switch 206 may be opened to permit recharging of the breakdown capacitance 204 without the charging current passing through the transformer to the switch 206.

In some embodiments, applying a breakdown voltage to the electrode(s) of a plasma generator may include applying the breakdown voltage from an energy storage device to the electrode(s) via a transformer. For example, as shown in FIG. 2, the transformer further couples a follow-on capacitance 214 to the plasma generator 240 on the secondary side. In some embodiments, upon closing of the breakdown switch 206, current may flow from the follow-on capacitance 214 through the secondary coil 216b of the transformer 216 to the plasma generator 240. While the illustrated embodiment shows application of breakdown energy to the primary coil 216a using a different energy storage device than application of breakdown energy to the secondary coil 216b, a shared energy storage device may be used to apply energy to both the primary coil 216a and the secondary coil 216b in other embodiments, as the present disclosure is not so limited.

Similarly, in some embodiments, applying follow-on electrical energy to the electrode(s) may include applying the follow-on electrical energy from an energy storage device to the electrode(s) via a transformer. For example, after breakdown, additional current may flow from the follow-on capacitance 214 to the plasma generator 240 via the secondary coil 216b of the transformer 216, which is the same path as the breakdown voltage in the illustrated embodiment. In other embodiments, separate energy storage devices (e.g., capacitances) may be used for application of breakdown voltage and follow-on energy.

In some embodiments, the transformer 216 may have a saturable core. For example, the transformer 216 may have a low turns ratio (e.g., 37:1) to produce a low breakdown voltage and saturate upon application of sufficient current through the secondary coil 216b. For instance, a transformer core may be at least partially saturated when the secondary coil 216b inductance becomes significantly less inductive due to the core (e.g., ferromagnetic material about which the secondary coil is wound) taking on behavior of air, and/or the secondary coil 216b becoming substantially decoupled from the primary coil.

In some embodiments, the (e.g., saturable) core of the transformer 216 may be saturated by application of the breakdown voltage and may remain at least partially saturated at least through (e.g., controlled) application of electrical energy following breakdown. For example, by keeping at least partial saturation of the transformer 216 at least through application of follow-on electrical energy, current applied to the secondary coil 216b during at least partial saturation may encounter a low inductance and produce a low voltage drop across the secondary coil 216b while passing through to the plasma generator 240 to flow through the plasma.

In some embodiments, applying the breakdown voltage and/or applying the follow-on current may include closing a switching element coupled in a path from the plasma generator that includes an energy storage device and a transformer. For example, in FIG. 2, the plasma generation circuitry 200 further includes a switch 218 coupled in a path from the plasma generator 240 through the secondary coil 216b of the transformer 216 to the follow-on capacitance 214 and further to ground via the switch 218. In other embodiments, the switch 218 may be coupled between the plasma generator 240 and the secondary coil 216b of the transformer 216, and/or between the secondary coil 216b of the transformer 216 and an energy storage device. While a single switch 218 is shown in FIG. 2, it should be appreciated that multiple switches may be included in a switching element, such as multiple series and/or parallel connected switches. According to various embodiments, a switching element may include an isolated gate bipolar transistor (IGBT), a thyristor such as a MOS-controlled thyristor (MCT).

In the illustrated embodiment, a diode 220 is further coupled to a point between the follow-on capacitance 204 and the secondary coil 216b of the transformer 216, such as to create a reference voltage point (e.g., close to 1 V above ground in FIG. 2) between the follow-on capacitance 204 and the secondary coil 216b while the switch 218 is closed. As will be understood by those skilled in the art, the addition of diode 220 in the ground connection of the secondary coil 216b will operate to block current flowing back into the secondary 216b during the initial breakdown. Thus, an impedance of suitable magnitude is included in parallel with the diode 220 to provide a return path from ground to the secondary. This impedance may be a resistor 221, as shown, or in other embodiments may be a capacitance that permits the impulse-like current from the breakdown discharge to return to the secondary. These and other such solutions for the return path across diode 220 will be evident to those skilled in the art.

Also shown in FIG. 2, a power supply 236 is coupled to the follow-on capacitance 214 to charge it via diode 220. A blocking diode (not shown) may be coupled between the follow-on capacitance 214 and the power supply 236 to permit charging of the follow-on capacitance 214 and to block any return flow of electrical energy back to the power supply 236.

In some embodiments, the plasma generation circuitry may be configured to actively control application of follow-on energy to the plasma generator. For example, in FIG. 2, the plasma generation circuitry 200 further includes current control circuitry 222. In the illustrated embodiment, the current control circuitry 222 includes a feedback loop incorporating feedback from a current sensor 226 into a feedback signal 224. For instance, the feedback loop may be configured to regulate an amount of current flowing through the secondary coil 216b (e.g., corresponding to current flowing through the plasma) by comparing a sensed amount of current flowing through the switch 218 to a threshold current level (e.g., set by a control voltage V_{CTRL}), and enable the secondary side signal 234 to turn on the switch 218 using a control signal based on the sensed amount of current. In the illustrated embodiment, pulse shaping 228 is also applied, such as may be used to control a rise time and/or fall time of a pulse of follow-on current.

It should be appreciated that other plasma generation circuitry configurations may be used depending on the application. For example, where a sufficiently low breakdown voltage may be used (e.g., where a treated ceramic isolator surface provides for a very low breakdown voltage), the breakdown voltage and/or follow-on current may be delivered directly to the plasma generator from an energy storage device, such as without first passing through an inductance. For instance, an energy storage device may be coupled directly to a plasma generator by a switching element.

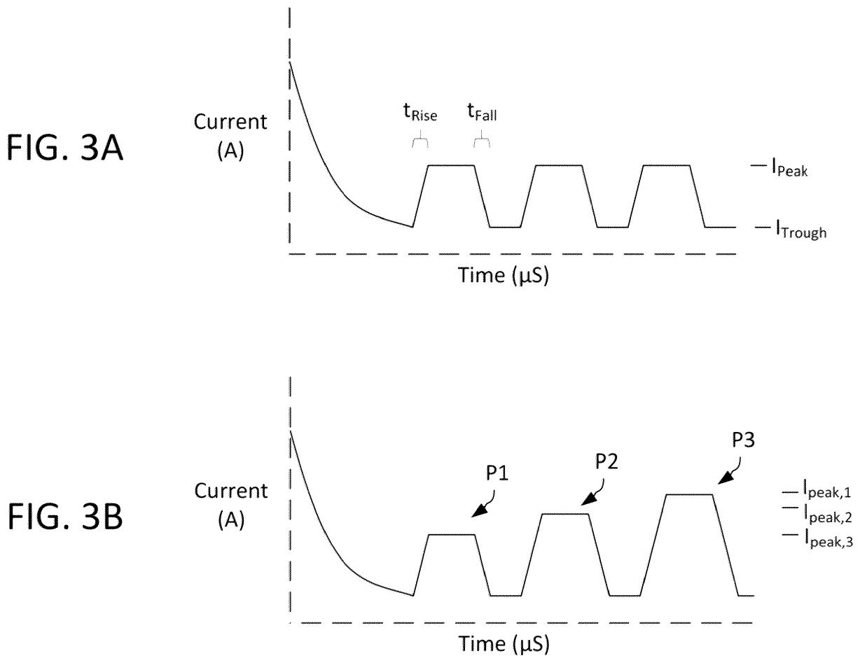

FIG. 3A illustrates example application of follow-on current following breakdown in the plasma generation system of FIG. 1A, according to some embodiments.

As shown in FIG. 3A, breakdown may be followed by a decline in current through the plasma, such as due to at least partial plasma recombination. In the illustrated embodiment, a sequence of at least three pulses of follow-on current are applied (e.g., additional pulses may be applied after the illustrated timeframe). For example, the follow-on current pulses shown in FIG. 3A may be applied using circuitry shown in FIG. 2, though other circuitry configurations could be used. It should be appreciated that fewer pulses than illustrated may be applied, depending on the embodiment.

In some embodiments, applying follow-on current may include altering a rate of current decay through the plasma with respect to current decay following breakdown without the follow-on current. For example, as shown in FIG. 3A, the current decay following breakdown is altered by the three pulses of follow-on current. In some embodiments, altering the rate of current decay may include actively applying follow-on current to produce a higher current than would be flowing through the plasma following breakdown without applying the follow-on current. For example, in FIG. 3A, current flowing through the plasma is higher at each illustrated pulse than the current would be according to the decay curve that precedes the pulses. For instance, application of follow-on current may include using at least one active circuit element, such as a switching element.

In some embodiments, applying follow-on current may include applying, to the electrode(s), at least two pulses of current (e.g., having at least the peak current described herein as exceeding 450 A). For example, in FIG. 3A, each pulse is shown having a peak current Iₚₑₐₖ, which is the same for each pulse in FIG. 3A, though need not be (e.g., see FIG. 3B). For instance, in FIG. 3A, each illustrated pulse may have a peak current Iₚₑₐₖ exceeding 450 A, and at least one of the pulses shown in FIG. 3A may reach the peak current Iₚₑₐₖ at least two microseconds following breakdown. It should be appreciated that while square pulses (e.g., trapezoidal pulses due to nonzero rise and fall times in a practical implementation) are shown in FIG. 3A, other pulse shapes may be used such as triangle and/or sinusoidal pulses.

In some embodiments, applying the follow-on current and/or pulse of current may be before a next application of the breakdown voltage to the electrode(s). For example, as shown in FIG. 3A, the current through the plasma does not rise to its post-breakdown decay level before application of the illustrated pulses. It should be appreciated that some at least partial recombination of the plasma may occur prior to at least some applied follow-on current, which may result in a breakdown voltage lower than the applied breakdown voltage being applied (e.g., using a voltage across the secondary coil of the transformer, which may become at least partially unsaturated) before at least some of the applied follow-on current.

According to another aspect of the present disclosure, a follow-on current may have a pulse having a rise time shorter than 10 μs. For example, the rise time may be shorter than 5 μs, and/or shorter than 3 μs. For example, in FIG. 3A, the first illustrated pulse has a rise time t_{Rise} and a fall time t_{Fall}. In some embodiments, the rise time t_{Rise} and/or the fall time t_{Fall} may be controlled to produce a pulse of follow-on current that contributes a sufficient Lorentz force (e.g., for plasma propagation) and/or at least prevents total recombination of the plasma while limiting time during which a given point along the electrodes is exposed to wear. It is recognized that rise and/or fall times of pulses of follow-on current may be a useful tool for balancing wear on the electrodes with beneficial application of electrical energy to the electrodes.

In some embodiments, at least two pulses of current, including a pulse having the rise time and/or the fall time (e.g., shorter than 10 μs, and/or shorter than 5 μs), may be applied at a time at least two microseconds following breakdown. For example, in FIG. 3A, the first illustrated pulse may be applied at a time at least two microseconds following breakdown and include such a short rise time and/or fall time. Alternatively or additionally, other ones of the illustrated pulses may be applied at a time at least two microseconds following breakdown and include such a short rise time and/or fall time. In the illustrated embodiment, each pulse is shown having the same rise time and fall time, though that need not be the case (e.g., see FIG. 3B).

In some embodiments, follow-on current including a pulse having such a short rise time and/or fall time may be delivered using circuitry described herein including in connection with FIG. 2. For example, the follow-on current may be applied from an energy storage device via a transformer having a saturable core, and the core may remain at least partially saturated at least through application of the follow-on current. In some embodiments, pulse shaping and/or current monitoring feedback may be used to achieve a desired rise time and/or fall time. In some embodiments, a switching element coupled in a path from the plasma generator that includes the energy storage device and the transformer.

In some embodiments, applying follow-on current through the plasma including such a short rise time and/or fall time may further include propagating the plasma along a length of the electrodes, such as described herein. For example, controlling the rise and/or fall time may be useful in achieving a Lorentz force for propagating the plasma in a controllable manner and while limiting wear at any point along the electrodes.

In some embodiments, at least distal tips of the electrodes may be only proximate to an environment having a pressure below 300 PSI (or below 175 PSI, or below 150 PSI) while the follow-on current (e.g., a pulse thereof having such a short rise and/or all time) is applied.

In some embodiments, at least two pulses of follow-on current (e.g., the three illustrated pulses) may (e.g., alone or in combination with the breakdown voltage) contain an amount of energy sufficient to controllably propagate plasma along the electrodes without causing beyond a threshold amount of thermal expansion, such as described herein.

In some embodiments, as an alternative or in addition to having a relatively short rise time and/or fall time, a pulse of follow-on current such as shown in FIG. 3A may have a current rate-of-change with an absolute value exceeding 90 A/μs (e.g., exceeding 130 A/μs). For example, the first illustrated pulse is shown changing from a low current level I_{Trough} to the peak current level I_{Peak} linearly over a rise time t_{Rise}, resulting in a current rate-of-change over the rise time t_{Rise} of (I_{Peak}-I_{Trough})/t_{Rise}. Similarly, the illustrated fall time t_{Fall} results in a current rate of change over the fall time t_{Fall} of (I_{Trough}-I_{Peak})/t_{Fall}. While the current rates-of-change in the illustrated example have opposite signs for rise and fall, they have a same absolute value. It should be appreciated that a current rate-of-change may be instantaneous and/or derived from a non-linear change in current (e.g., a sinusoidal peak) such as using a slope of a tangent line. It should be further appreciated that a current rate-of-change may have a different absolute value for a rise time of a pulse and for a fall time of a pulse, such as where a pulse is asymmetrical with time as compared to the example shown in FIG. 3A.

FIG. 3B illustrates an alternative example application of follow-on current following breakdown in the plasma generation system of FIG. 1A, according to some embodiments.

In some embodiments, pulses of follow-on current may have different peak currents. For example, in FIG. 3B, a first pulse P1 is followed by a second pulse P2 having a second peak current I_{peak,2} that is higher than a first peak current I_{peak,1} of the first pulse P1. For example, the pulses of follow-on current may, at least for some pulses in a follow-on sequence, increase in peak current over time.

In some embodiments, a first follow-on current applied to the electrode(s) (e.g., at a first pair of points) may include the first pulse P1 and a second follow-on current applied at to the electrode(s) (e.g., at a second pair of points closer to the distal tips than the first pair of points are) may include the second pulse P2. For example, the second follow-on current may be applied through the plasma farther along a length of the electrode(s) (e.g., in length direction 115 in FIG. 1A) as part of propagating the plasma along the length of the electrode(s).

In some embodiments, more than two pulses of follow-on current may be applied before a next application of the breakdown voltage. For example, in FIG. 3, the second pulse P2 is followed by a third pulse P3. In the illustrated embodiment, the third pulse P3 has a third peak current I_{peak,3} that is shown higher than the first peak current I_{peak,1} and the second peak current I_{peak,2}, though in other embodiments the sequence of pulses may differ in relative peak current. For instance, the second pulse P2 may have a peak current higher than the first pulse P1 and the third pulse P3.

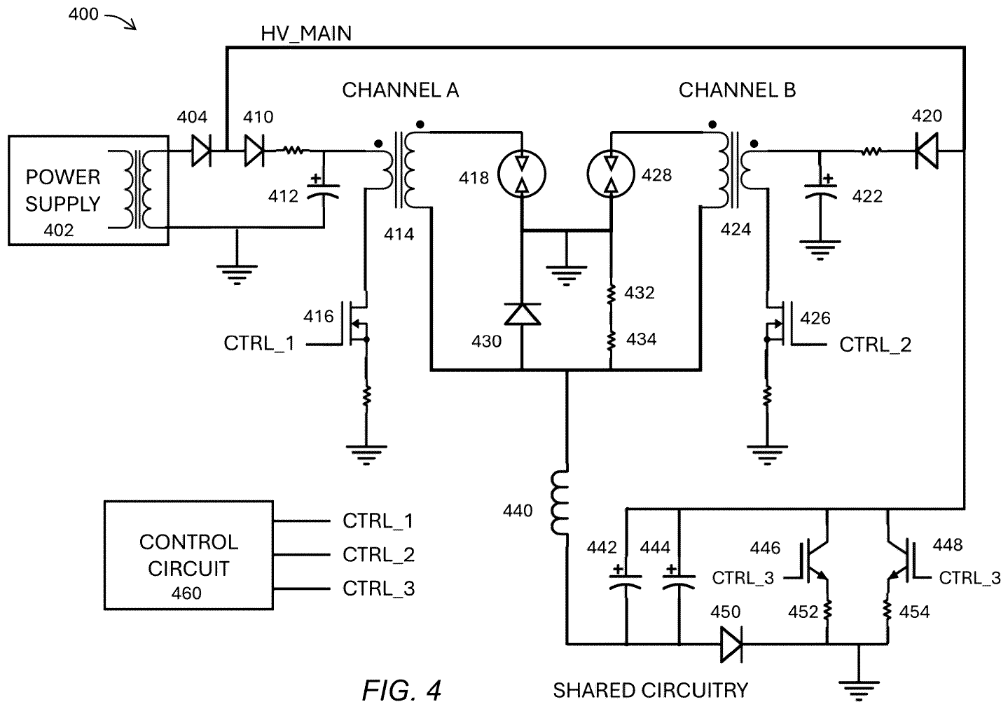

FIG. 4 depicts an embodiment 400 of a plasma generation system that utilizes shared circuitry to operate two separate plasma generators. In this example embodiment, the plasma generation system more specifically comprises an ignition system such as may be used in aerospace (aviation or space) applications to ignite a fuel for purposes of vehicle propulsion. Thus, the plasma generation circuity comprises an exciter and the plasma generators themselves comprises igniters of the ignition system.

Ignition system 400 includes two channels; that is, two different exciters each associated with one of the two igniters 418, 428. In general, ignition system 400 includes a separate circuit (Channel A and Channel B) that provides an initial breakdown voltage and current suitable to generate a plasma at each of the respective associated igniters 418, 428, and includes a single circuit (Shared Circuitry) that provides one or more subsequent pulses of electrical energy used to sustain the plasma at the igniters. Ignition system 400 also includes a control circuit that generates the control signals used by Channels A and B and the Shared Circuitry to initiate the breakdown and subsequent pulse(s). Control circuit 460 includes the logic and timing required to produce alternating plasma discharge events between the two Channels A and B, and the construction and operation of the control circuit 460 will be apparent to those skilled in the art. Thus, Channel A igniter 418 is fired and the plasma sustained using the Shared Circuitry until the plasma event concludes, followed by Channel B igniter 428 being fired and the plasma sustained using the Shared Circuitry until that plasma event concludes, and the sequence repeats.

To carry this out, ignition system 400 includes a power supply 402 that provides a HV_MAIN supply of suitable voltage (e.g., 200-1000 v) via a diode 404. This HV_MAIN is used to charge the energy storage devices used in Channels A and B and the Shared Circuitry (i.e., storage capacitors 412, 422, 442, and 444). For this purpose, power supply 402 can be implemented by a shuntable (short circuit protected) supply that continuously charges the storage capacitors when the control circuit outputs are all off (i.e., all transistors 412, 422, 446, 448 are switched OFF). Capacitor 412 of Channel A is charged by this HV_MAIN power via diode 410. Upon a positive voltage being output on CTRL_1, the MOSFET 416, acting as a switch, turns ON thereby causing the capacitor 412 to discharge through the primary of step-up transformer 414. This produces a large amplitude voltage across the secondary sufficient to initiate an arc across igniter 418. With the relative primary and secondary winding directions shown (dot at the top of each winding), the secondary current will flow through the igniter 418 and resistors 432, 434.

In an alternative embodiment of that shown in FIG. 4, the primary and secondary windings can be wound in opposite directions—for example, with the secondary winding dot at the bottom, such that the secondary current will flow in the opposite direction—i.e., through diode 430 and the igniter 418. In this alternative embodiment, the resistors 432, 434 can be eliminated.

Transformers 414 and 424 may have a saturable core. For example, the transformers may have a low turns ratio (e.g., 37:1) to produce a relatively low breakdown voltage and saturate upon application of sufficient current through the secondary coil. For instance, a transformer core may be at least partially saturated when the secondary coil inductance becomes significantly less inductive due to the core (e.g., ferromagnetic material about which the secondary coil is wound) taking on behavior of air, and/or the secondary coil becoming substantially decoupled from the primary coil.

In some embodiments, the (e.g., saturable) core of the transformers 414 and 424 may be saturated by application of the breakdown voltage and may remain at least partially saturated at least through (e.g., controlled) application of electrical energy following breakdown. For example, by keeping at least partial saturation of the transformer at least through application of follow-on electrical energy, current applied to the secondary coil during at least partial saturation may encounter a relatively low inductance and produce a low voltage drop across the secondary coil while passing through to the plasma generator to flow through the plasma.

The construction and operation of Channel B is the same as Channel A, with capacitor 422 being charged by the HV_MAIN through diode 420 and MOSFET 426 being operated using CTRL_2 from the control circuit 460 to discharge capacitor 422 through the primary of transformer 424 such that the secondary of that transformer initiates breakdown at igniter 428 via the same Shared Circuitry components 430, 432, 434 as discussed above, depending on the transformer wiring convention used.

The Shared Circuitry includes energy storage devices (capacitors 442, 444) that are used to provide subsequent, follow-on electrical energy to the igniters 418, 428 immediately after the initial breakdown and plasma formation. This is done by the control circuit 460 outputting one or more positive pulses on CTRL_3 that simultaneously operates IGBTs 446, 448 to discharge the capacitors 442, 444 through the secondary of whichever igniter is currently firing. Upon transistors 446, 448 turning on, diode 450 forces ground to rise to near the HV_MAIN voltage and those capacitors to discharge through ground into the firing igniter 418 or 428 and then through the secondary of the associated transformer and back to the capacitor via inductor 440. Because the subsequent pulse(s) generated by the shared circuitry may be created while the transformer secondary is still saturated, inductor 440 provides some additional impedance to limit the current.

When the transformers are constructed using the alternative winding direction discussed above, the subsequent current pulse(s) will flow through the igniter and transformer in the same direction as the initial breakdown current from the associated channel MOSFET.

### Short Protrusion Electrodes

Referring back to FIG. 1A, the electrodes 112a, 112b of igniter 100 have a length L comprised of a first (exposed) section L1 that extends out from a surface of the isolator, and a second (embedded) section L2 that extends from the surface down into the isolator. Advantageously, the lengths L1 and L2 are selected so as to 1) maintain a relatively short protrusion of the electrodes beyond the end of the isolator that is suitable for a particular application of the plasma generator and 2) extend a relatively longer distance within the isolator sufficient to create a Lorentz force that moves the plasma outward/y away from the isolator along the protruding length of the electrodes. The electrodes preferably, but need not have the same length.

In at least some embodiments the ratio of L1: L2 is in the range of 1:3 to 1:100, preferable over 1:5, more preferably over 1:10, and preferably not more that 1:100. In FIG. 1A, the electrodes have the same overall length L as well as the same lengths L1, L2 of the respective exposed and embedded portions. As will be evident from various embodiments described below, any or all of the lengths L, L1, and L2 of the electrodes may be different than one or more of the other electrodes of the plasma generator.

For traveling spark ignition (TSI) applications for which a high number of firings (30,000-100,00) is not needed over the service life of the igniter, the exposed, or firing, portion of the electrodes may be short compared to other TSI igniters since the lower number of firings of the igniter (e.g., <10,000, possibly less than 1,000 or less than 100) can involve increased electrode wear per firing, thus allowing for higher currents (e.g., >450 Amps, or >600 Amps, up to 1,000-2,000 Amps depending on duration), longer plasma sustainment, and greater plasma projection distances. These are some of the features that make the disclosed embodiments suitable as multi-firing replacement for one-shot or other pyrotechnical ignitions.

While the particular electrode protrusion (length L1) utilized for any specific application can vary within a large range of values, the disclosed plasma formation and projection techniques and igniter designs can be particularly advantageous for protrusion lengths L1 of 0.08 inches or less, including flush (zero protrusion) electrodes. Even electrodes recessed into the insulator, if necessary or desired, can be utilized.

For short protrusion electrodes in a TSI application, there must be sufficient electrode material extending below the plasma initiation region (which is typically the isolator surface between the electrodes) extending substantially in parallel to each other for the current flows to and from the electrodes to generate the Lorentz force needed to move the plasma outwardly away from the isolator. Hence, there must be sufficient length L2 for the electric field between the electrodes and the magnetic field generated by the linearly-flowing currents to push the plasma axially away from the end of the igniter.

Various diagrammatic and illustrative examples of these short protrusion electrode designs with a small L1 and larger L2 are described below.

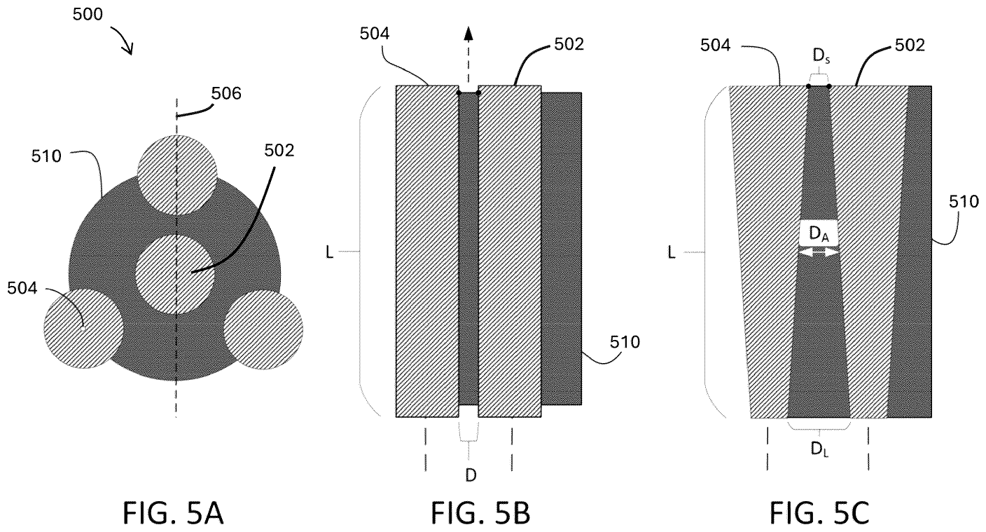

FIG. 5A illustrates a top view of an example plasma generator 500 having a concentric-electrode configuration that may be included in the plasma generation system of FIG. 1A, according to some embodiments.

According to various embodiments, a plasma generator may have any suitable electrode configuration. In some embodiments, the electrodes may be configured to conduct substantially parallel currents, such as by having central axes that are substantially parallel and/or having outer surfaces that are substantially parallel. For example, electrodes may be present in a coaxial configuration, such as with one electrode (e.g., central electrode) surrounded or at least substantially surrounded by another electrode (e.g., outer electrode). In the same or another example, more than two electrodes may be present, such as with some of the electrodes configured as anodes (e.g., receiving the breakdown voltage) and some of the electrodes configured as cathodes (e.g., receiving a reference voltage, or vice versa). For instance, FIG. 5A illustrates a rail configuration in which multiple outer electrodes are spaced from one another and from another electrode (e.g., a central electrode). The illustrated configuration of FIG. 5A shows one electrode configured as an inner electrode 502 and other electrodes configured as outer electrodes 504, but other configurations are possible. In the illustrated example, central axes 506 and outer surfaces of the electrodes are substantially parallel. As in FIG. 1A, the electrodes 502 and 504 shown are separated by an isolator 510. In one embodiment in which plasma generator 500 is used in the system of either FIG. 1A or 4, the center electrode 502 can be connected to a high voltage output of the plasma generator circuitry and the three outer electrodes 504 can be connected to the other (ground) output of the plasma generator circuitry.

FIG. 5B shows a cross section of the right portion of the plasma generator of FIG. 5A showing the center electrode 502 and the upper outer electrode 504 of FIG. 5A. As shown, an edge-to-edge distance D between the two electrodes of FIG. 5B can be identified as the nearest edge points of those two electrodes. Alternatively, the distance D can be taken (measured) as the distance between center points of each of the two electrodes (indicated by the lower dashed lines in FIG. 5B). Or, as another alternative, the distance D can be taken as the distance between the farthest-most points of the two electrodes, when viewed as a cross-section at any point along the lengths L of the electrodes.

FIG. 5C depicts electrodes having a different conformation and relative orientation that are non-parallel. This can be constructed by design or due to manufacturing tolerances, and are shown exaggerated in FIG. 5C. The distance D between the electrodes can be taken at any of the various different points (D_{S}, D_{A}, D_{L}, or any point therebetween). Wherever the distance D is measured, it can be used in connection with the length L of the electrodes to characterize advantageous relationships between these dimensions, relationships that can be utilized for various embodiments depending upon the needs or desirability for various applications. This will be understood by and of use to those skilled in the art.

For example, one advantageous characterization of the electrode configuration for use with the illustrated embodiments is based on the relationship of the length of the exposed portion of the electrodes relative to the width of the gap between the electrodes at the initiation region (e.g., the surface of the isolator). This is useful for applications where longevity has significance at a similar proportion to flow disturbance. The plasma moves a bit from Lorentz force, generating more swept volume than a non-TSI based system would and the field below the initiation region ensures reliable motion, but extending the plasma slightly—without aggressively burning the electrode tips. In this case, a preferable trade off would be around 1.75:1 exposed electrode length to gap width. Generally, a protrusion length that is no more than three times the gap width (3:1 ratio) will be suitable. In other embodiments, the ratio can be 2.25:1 or less, 2.0 or less, and even down to zero, such as for electrodes that lie flush with the end surface of the isolator.

In some embodiments, the plasma generator 110 shown in FIG. 2 may be the same plasma generator 110 shown in FIG. 1A forming the reaction environment 150. For example, the plasma generator 110 may be configured to form a first plasma resulting from the plasma generation circuitry 120 applying a voltage sufficient to cause breakdown at a first time, resulting in the reaction environment 150. In this example, the plasma generator 110 may be configured to form a second plasma resulting from the plasma generation circuitry 120 applying at least one controlled pulse of electrical energy at a second time following the first time.

In some embodiments, the plasma generator 240 shown in FIG. 2 may be another plasma generator 240 of the plasma generation system 500. For example, a first plasma generator 110, shown in FIG. 1A, may be configured to form a first plasma resulting from the plasma generation circuitry 120 applying thereto a voltage sufficient to cause breakdown at a first time. In this example, a second plasma generator 240, shown in FIG. 2, may be configured to form, sustain, and/or propagate a second plasma resulting from the plasma generation circuitry 120 applying thereto at least one controlled pulse of electrical energy at a second time following the first time.

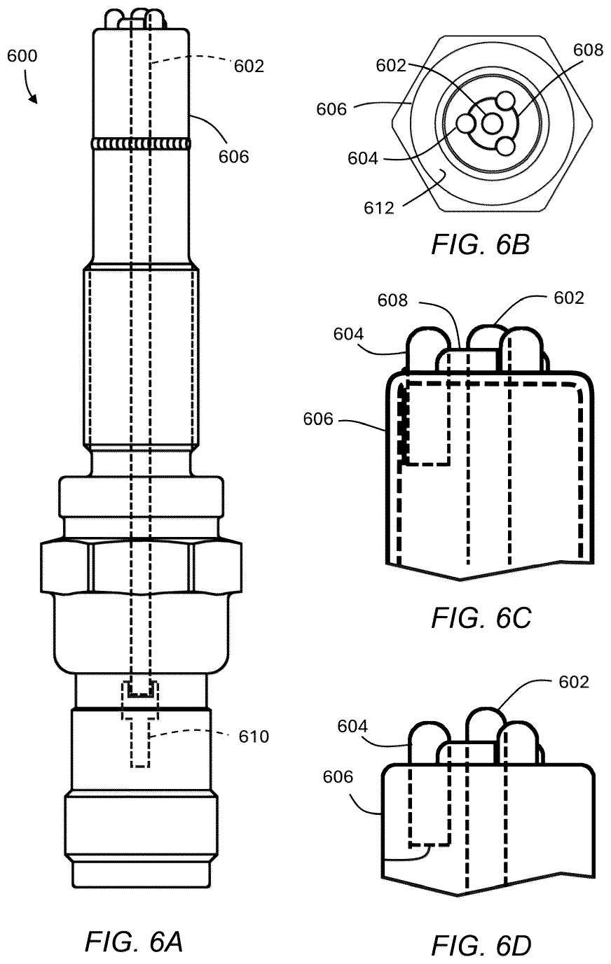

FIGS. 6A-6D show an igniter and firing end electrode designs implemented in a mostly typical aviation turbine engine igniter design. FIG. 6A is a perspective view of the full igniter 600 that may be used in the plasma generation systems of FIGS. 1A and 4.

The igniter 600 has a plurality of electrodes including an anode center electrode 602 and a cathode electrode 604 extending from a cathode shell 606 and separated by an isolator 608. The illustrated igniter has a rail configuration with multiple cathode electrodes 604 extending from the cathode shell around the anode electrode 602. In some embodiments, the illustrated igniter 600 may be coupled to ignition circuitry (e.g., FIG. 2 or 4) to receive electrical energy for plasma generation, growth, and/or propagation along the igniter (e.g., upward in FIG. 6A). Shown in hidden lines is a center electrode that extends through the igniter to a metal circuit connecting piece 610 such that the igniter may be used with an ARP-style ignition lead connector (not shown). The cathode shell 606 functions as a second circuit connection piece, whereby a breakdown voltage and follow-on pulses can be applied across the two circuit connection pieces to provide the ionization and spark energy to the electrodes 602 and 604.

FIG. 6B is a top view of the igniter 600 of FIG. 6A. The firing end includes the center electrode 602 extending out of a central bore in the isolator 608. Surrounding the electrode 602 are three of the cathode electrodes 604, each of which is welded or brazed to an upper shell surface 612 that is formed as a part of the overall firing end shell 606. As shown diagrammatically in FIGS. 6C and 6D, the outer electrodes 604 can be welded internally to the shell 606 or otherwise electrically connected to the shell as indicated in FIG. 6D. Also, as shown in these two figures, the electrode protrusions from the shell cap 612 can either be the same (FIG. 6C) or different (FIG. 6D). Also, in FIG. 6C, due to the isolator 608 projecting from the shell cap 606, the length L1 of the exposed, firing portion of the center electrode 602 is less than that of the outer electrode 604.

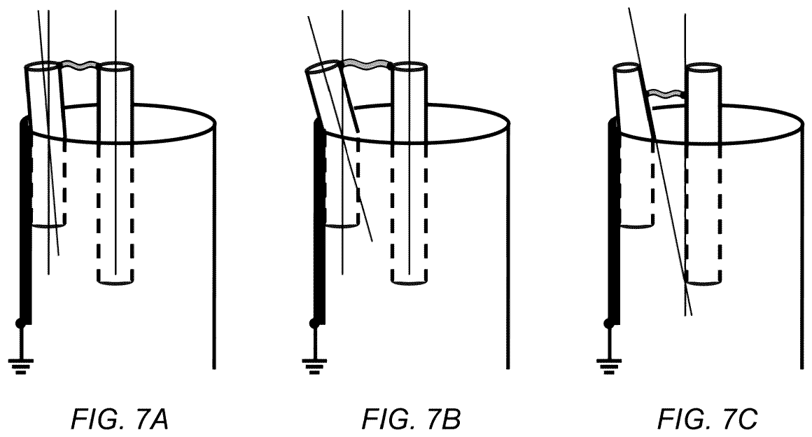

Preferably, the electrodes are oriented strictly parallel for at least some of their length both above and below the plasma initiation region (typically the isolator axial end surface). That orientation provides a constant electric field between the electrodes along their parallel length and allows the magnetic fields from the current through the two conductors to align such that the resulting Lorentz force acts axially from the igniter (away from the isolator end surface) so as to enable the plasma to move toward the distal ends of the electrodes. However, a certain amount of non-parallelism can be tolerated without a significant reduction in Lorentz force. FIGS. 7A-7C diagrammatically illustrate various non-parallelism configurations. In FIG. 7A, the electrodes are regular cylinders having a uniform diameter along their exposed length. However, the exposed portion of the electrode is angled outwardly away from the center electrode by a small angle of about 5°. In this configuration, the electrodes are considered to be substantially parallel without much noticeable impact on Lorentz forces and plasma travel.

FIG. 7B shows a configuration as in FIG. 7A, but with a more significant angle of the outer electrode relative to the center electrode-about 20°. In this configuration, the electrodes are considered nearly parallel and some impact on the strength of the Lorentz force can be expected. With enough energy (current) put into the plasma, outward propagation of the plasma can still occur. Note that the diverging electrodes of FIG. 7B require the plasma to bridge a greater distance as it travels to the distal ends of the electrodes, as compared to that of FIG. 7A.

FIG. 7C depicts an outer electrode that has a diminishing diameter towards its distal end. Thus, as indicated in FIG. 5C, even if the electrode axis is parallel with that of the center electrode, the slight conical shape can create a greater (or lesser) distance between the electrodes thereby affecting the electric field as well as the magnetic field direction where the current is concentrated towards the lengthwise portions of the electrodes nearest each other.

### Virtual Electrodes

Through experimentation, it has been found that it is possible to propagate the plasma not only to the distal ends of the electrodes, but also project the plasma past those ends by a significant distance. With a suitably high current in the follow-on pulses, it has been discovered that the plasma can be projected to one or more inches beyond the distal tips of the electrodes, and that this occurs by effectively forming virtual electrodes that extend from the distal tips of the actual, physical electrodes.

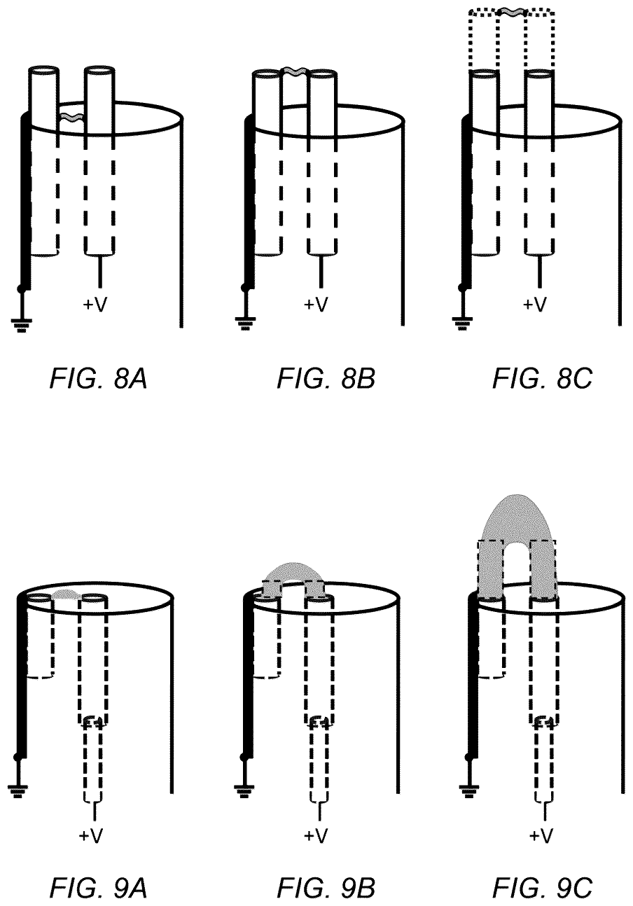

FIGS. 8A-8C diagrammatically illustrate this effect. In FIG. 8A, a plasma is initiated between two projecting electrodes. This plasma exists primarily between the closest points of the two electrodes to each other, where the electric charge builds up prior to breakdown. The surface of the isolator typically provides a slightly more conductive path than directly through the ionizable gas between the exposed portions of the electrodes. After initial plasma formation, but prior to total plasma recombination, one or more follow-on pulses are delivered to the electrodes, thereby sustaining the plasma and generating Lorentz force that propagates the plasma out to the distal ends of the electrodes, as indicated in FIG. 8B. From initial formation to the point of reaching the distal ends of the electrodes, the plasma extends transversely between the electrodes with the current flow through the plasma being almost entirely transverse. By continuing the delivery of high current pulses to the electrodes, the electron emission and reception of the two electrodes moves from the facing sides of the electrodes to their distal tips such that the electrons emit out of and are received into the distal tips of the electrodes. This has the effect of forming virtual electrodes comprising the stream of electrons (current) flowing into and out of the distal tips in substantially the same direction as their flow through the physical electrodes. Thus, the plasma blooms outwardly away from the plasma generator such that the plasma has both axial (in line with the electrodes) and transverse portions. This is shown in FIG. 8C. Due to the axial current flow in the axial portions (virtual electrodes) of the plasma, there is a Lorentz force from the current flow that continues to push the transverse portion of the plasma outwardly. Accordingly, these virtual electrodes become self-sustaining and can continue to grow in length away from the igniter, within limits.

FIGS. 9A-9C depict the same progression as shown in FIGS. 8A-8C, but using flush (zero protrusion) electrodes and showing the basic plasma plume shapes. Note that the Lorentz force contribution to the outward propagation of plasma from the current flowing through the physical electrodes diminishes as the plasma projects outwardly. Thus, once the virtual electrodes begin forming and growing in length, the Lorentz force contribution from the current flowing in the physical electrodes decreases for any particular magnitude of applied current.

More specifically, once the virtual electrodes develop, the total Lorentz force acting on the transverse portion of the plasma extending between the electrodes is produced in part from the current flow through the physical electrodes at their distal tip and in part from that same current flow through the virtual electrodes. As the virtual electrodes grow in length, there is a continuing decrease in the percentage contribution from the current flow in the physical electrodes to the Lorentz force acting on the transverse portion of the plasma, as well as an increase in the percentage contribution of the current flow in the virtual electrodes to the Lorentz force acting on the transverse portion of the plasma. Thus, the percentage contribution to the total Lorentz force acting on the transvers portion of the plasma from the current flow inside the physical electrodes has an inverse relationship with the length of the virtual electrodes.

For applications in which igniter firing end disturbances to combustion or ionization based thrust needs to be kept to a minimum, the use of flush, or very short protrusion electrodes (e.g., less than 0.08 inches, or less than 0.04 inches) can provide significant benefits to the engine design and performance.

### Disconnectable Igniters and Connectors

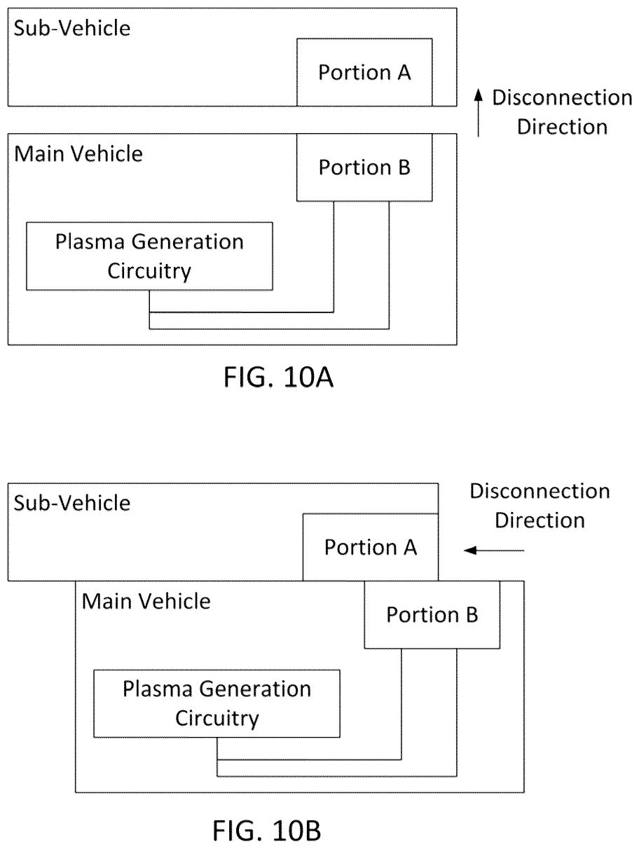

In connection with the plasma generator designs and considerations noted above for applications involving limited repeat firings, FIG. 10A diagrammatically illustrates a main vehicle that includes a launcher and sub-vehicle comprising a projectile. As shown, the launcher includes the plasma generation circuitry that comprises a first portion A and a second portion B. Portion A can include a minimal feasible separation portion of the plasma generator, that may include, for example, the distal portion of the plasma generator comprising an end or distal portion of the isolator and at least the exposed sections of the electrodes across which the plasma extends. Portion B comprises the remaining portion(s) of the plasma generator, such as the proximal ends of the isolator and electrodes, an outer shell, ignition wires connected to the plasma generation circuitry, etc. The embodiment of the vehicle shown in FIG. 10A is designed for separation in the vertical direction shown; that is, in a direction where the Portions A and B separate by moving in opposite relative directions.

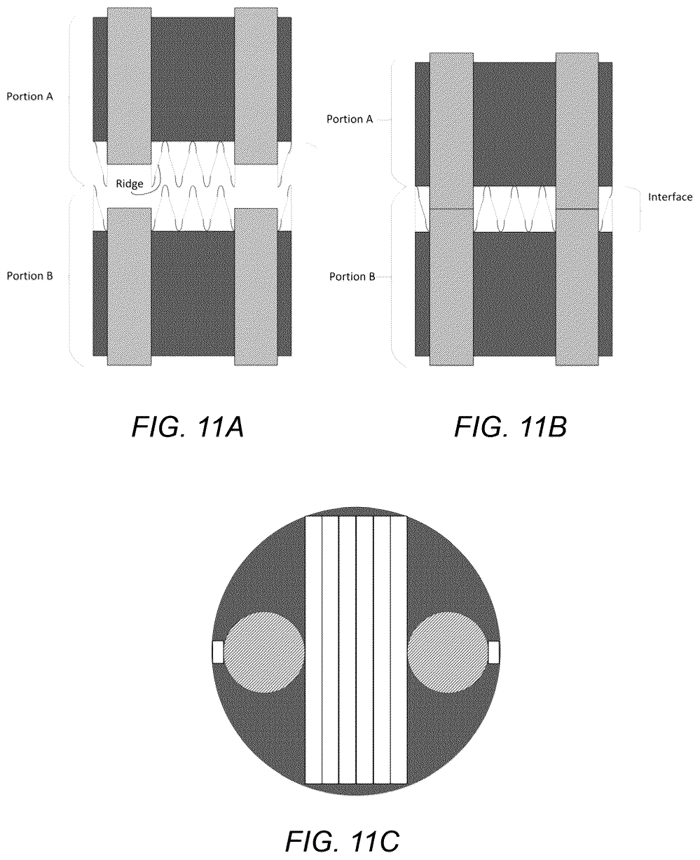

Referring to FIGS. 11A and 11B, for this opposite-direction separation, the isolator can be constructed to have ribbed or sinuous mating portions that (while not cross-hatched in the figures) are unitary sections of the two isolator portions that mate together as shown in FIG. 11B prior to projectile launch, such that the sinuous/ribbed isolator surfaces form an elongated path to prevent discharge of electrons between the electrodes across its surface. This helps ensure that the plasma discharge only occurs at the upper distal (exposed) ends of Portion A.

FIG. 10B depicts another embodiment of a main vehicle as in FIG. 10A except that the vehicle is constructed such that the projectile separates in a direction perpendicular to that of the FIG. 10A embodiment. That is, the projectile departs from the launcher in a sliding or parallel direction to that of the launcher, which can be useful for firing a projectile in the same or opposite direction as the movement of the main vehicle. FIG. 11C depicts an example of an isolator having linear ribs that provide dielectric isolation of the electrodes while permitting a sliding separation of the Portions A and B of the plasma generator in the manner shown in FIG. 10B. This approach can be refined into a rectangular connection with a point or lengthened (in the direction running along the path of the ridges) polarity placed centrally, with the second polarity surrounding it. A secondary ridge pattern could be created that would increase the discharge path along the ridges while shortening the connector structure, a variation of this this would allow for unidirectional separation.

Several different disconnectable igniter and ignition lead component designs will now be described that can be used for the main/sub-vehicle configurations described above in connection with FIGS. 10A and 10B, including, in each example, the two Portions A and B

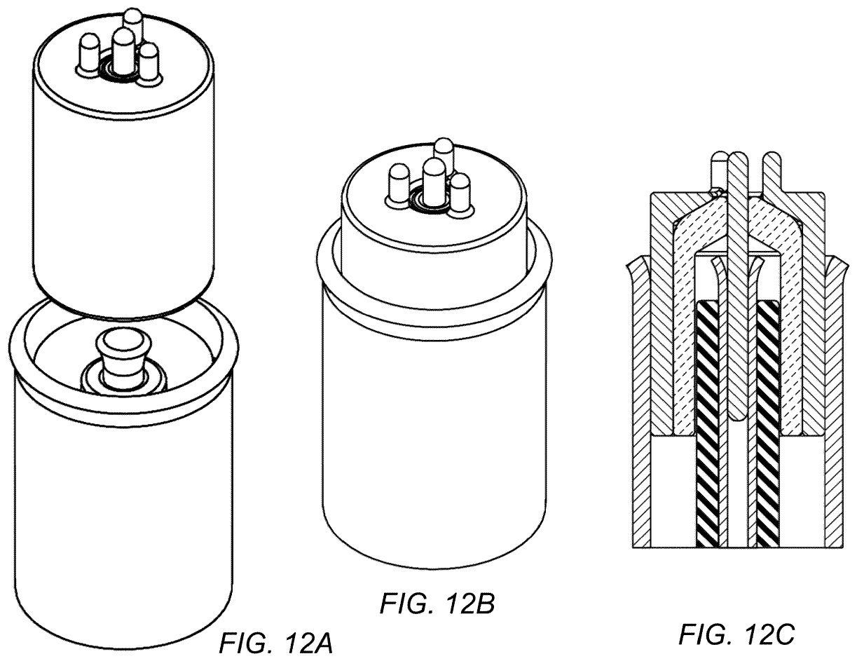

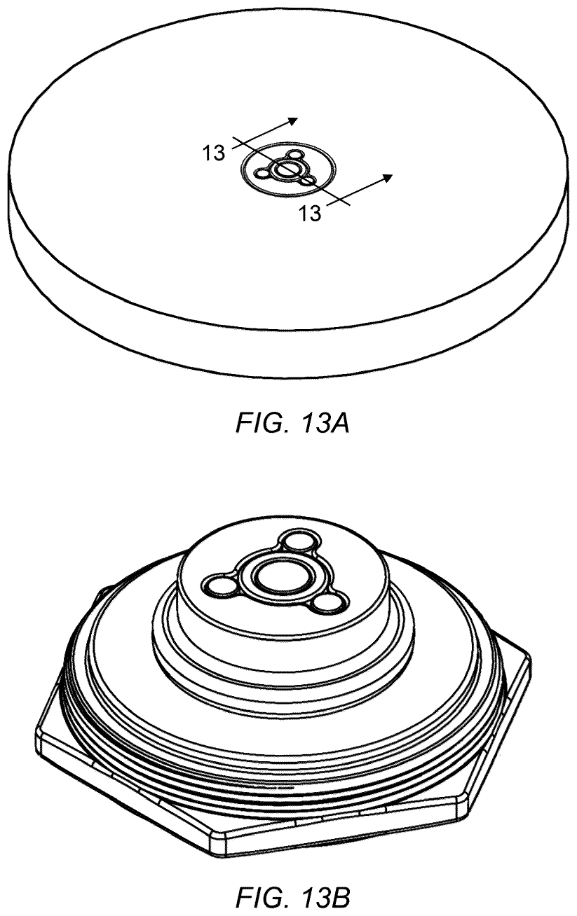

Turning to FIGS. 12A-12C, there is shown an igniter and mating connector piece that may be used for a disconnectable friction fit and electrical connection of two isolated igniter leads to plasma generation circuitry such as is shown in FIGS. 1A and 4. As evident from FIG. 12C, the interconnection is similar to an ARP670-type ignition lead connector for an igniter such as shown in FIG. 6A. This arrangement permits simple friction-fit disconnection along an axial direction of the igniter and connector.

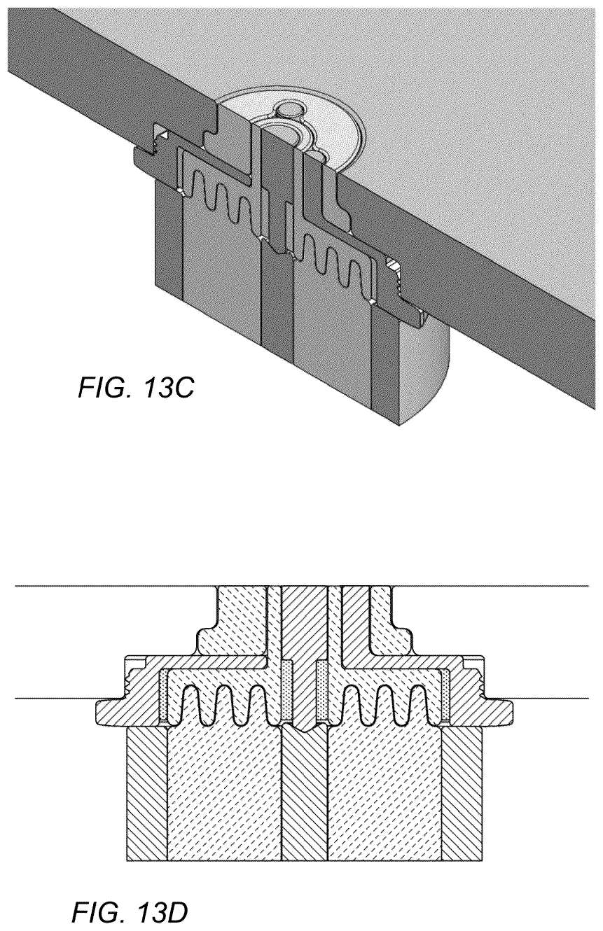

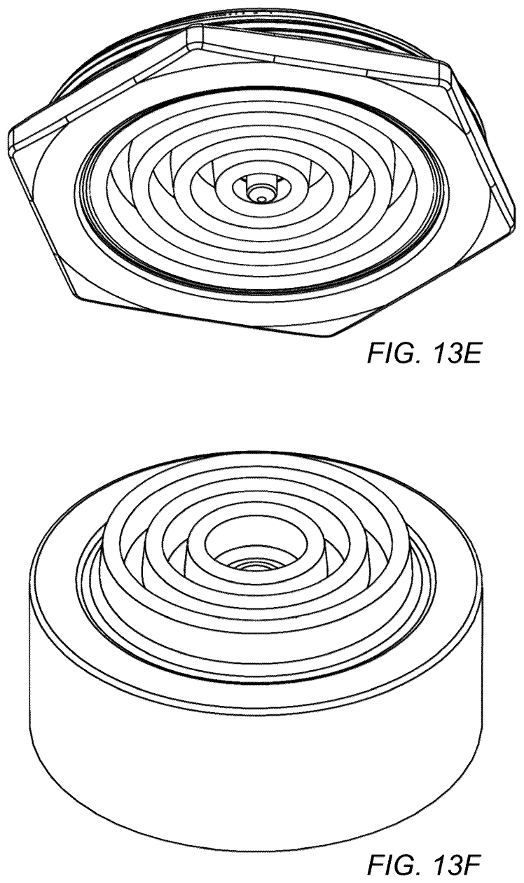

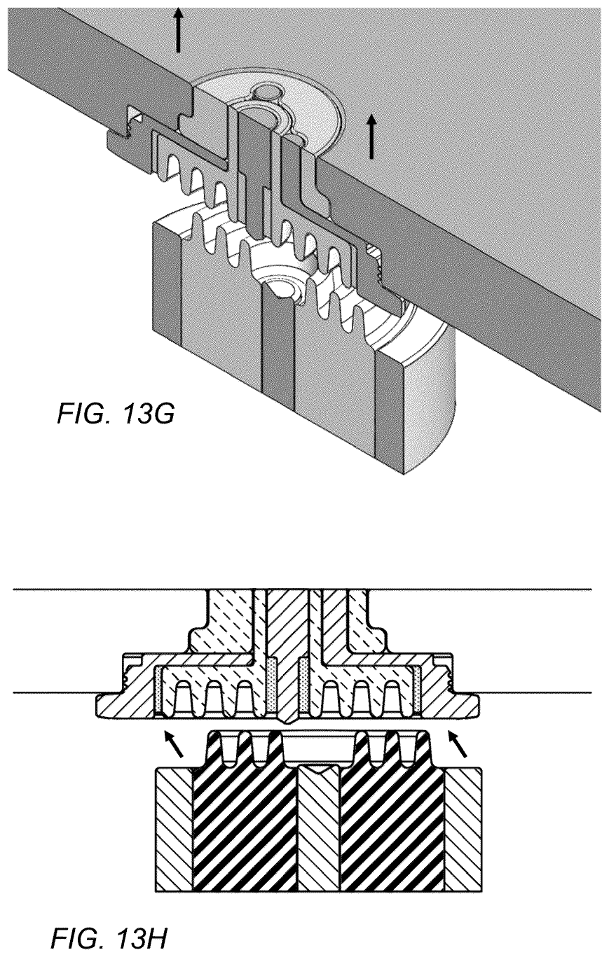

Referring now to FIGS. 13A-13H, there is shown a puck-shaped igniter that may be installed in an aperture of a wall or other component of a combustion chamber so as to expose the igniter electrodes to a reaction environment in the chamber while having little to no impact on the flow of gases through the chamber. FIG. 13B shows the igniter per se whereas FIGS. 13C and 13D show the igniter installed in the aperture of the combustion chamber as well as a lower connector mated with the igniter. As shown in FIGS. 13B-13D, the igniter includes a one-piece housing comprising a center hold in which is mounted an isolator having a flat surface at a firing end of the igniter and a ribbed surface at an axially-opposite end of the isolator. Within a central bore of the insulator is a center electrode that extends between axial ends of the igniter. The housing has an outer radial flange configured as an external hex head for engagement and tightening of the igniter in the aperture by a wrench. Just above the hex head is an annular housing portion having external threads that mate with internal threads of the outer stepped portion of the aperture in the chamber wall.

Above the threaded portion of the housing is a smaller-diameter top wall of the housing that extends radially inwardly to the housing's center hole. Extending upwardly from the top surface of the top wall of the housing are three outer electrodes that are together positioned concentrically around the isolator and center electrode. The final component of the igniter is an outer insulator surrounding the outer electrodes, isolator, and center electrode. The outer insulator include a circular outer perimeter and a partially circular inner perimeter that has an inset channel (or recess, or lobe) to accommodate each of the three outer electrodes. As will be appreciated by those skilled in the art, this rib structure presents a lengthy surface across while charge would have to move in order to short between the center electrode and outer housing. The igniter includes glass seals of the isolator and outer insulator to secure them and the center electrode to the housing.

The center electrode, isolator, outer electrodes, and outer insulator together make up the firing end of the igniter that is exposed to the reaction environment when in use. As is evident from the figures, these four component each have the same axial protrusion such that they together form a substantially-continuous flat surface. As shown in FIGS. 13A, 13C, and 13D, by suitable dimensioning of the igniter, when installed in the aperture in the combustion chamber wall, this exposed firing end can be situated flush with the inside surface of the chamber wall, thereby minimizing an impact of the igniter on the combustion chamber fluid dynamics.

Moreover, when utilized in connection with “on-short” or other short duration service applications, the igniter can be used with the plasma generation circuitry described above to produced well-projected plasma into the reaction environment. Furthermore, the inclusion of the ribbed insulator surface at the other axial end of the igniter allows the igniter to be mated to a ignition lead or other component that permits automatic disconnection of the igniter from the remaining portions of the ignition system. This is particularly useful for launching a sub-vehicle from a main vehicle since the igniter can stay secured to the sub-vehicle combustion chamber while the bulkier remaining portion of the ignition system may remain with the main vehicle.

FIG. 13E shows the ribbed surface of the igniter's isolator as a series of concentric ribs of insulative material like ceramic. The mating connector shown in FIG. 13F includes its own isolator having an upper, complementary ribbed surface that mates with that of the igniter's isolator. The electrical connections between the connector and the igniter's center electrode and housing are surface-to surface contact, although other suitable, disconnectable interconnections may be used, as will be evident to those skilled in the art.

As indicated by the arrows in FIG. 13G, the igniter and connector arrangement of FIGS. 13A-13F utilize an axial disconnection direction. FIG. 13H shows an alternative embodiment of the connector in which its isolator is formed of a rubber or other pliable or flexible material. As indicated by the arrows in these figures, this permits a disconnection direction other than purely axial since the ribs of the connector isolator are able to flex as the igniter moves relatively away from the connector.

In various embodiments, the igniter of FIGS. 13A-13H may have dimensions within the following ranges. The overall igniter puck thickness can be in the range of 0.1-2 inches or, in some embodiments, in the range of 0.25 and 1 inch. The hex head thickness may be in the range of 0.1 to 1 inch. The diameter of the threaded portion of the housing may be in the range of 0.25 to 2 inches or, in some embodiments, in the range of 0.375 to 0.75 inches. The outer insulator diameter can be in the range of 0.25 to 2 inches. The outer electrode axial length may be at least 0.1 inches long below the plasma initiation region and preferably greater than 0.25 inches. The exposed projection of any of the electrodes depends on the application to which the igniter is applied, any can be anywhere in the range of 0 (flush with isolator) up to 2 inches. The center electrode and outer electrode diameters/cross-sectional area can be selected as required for a particular application, and in some embodiments may be in the range of 0.04 to 0.4 inches in diameter.

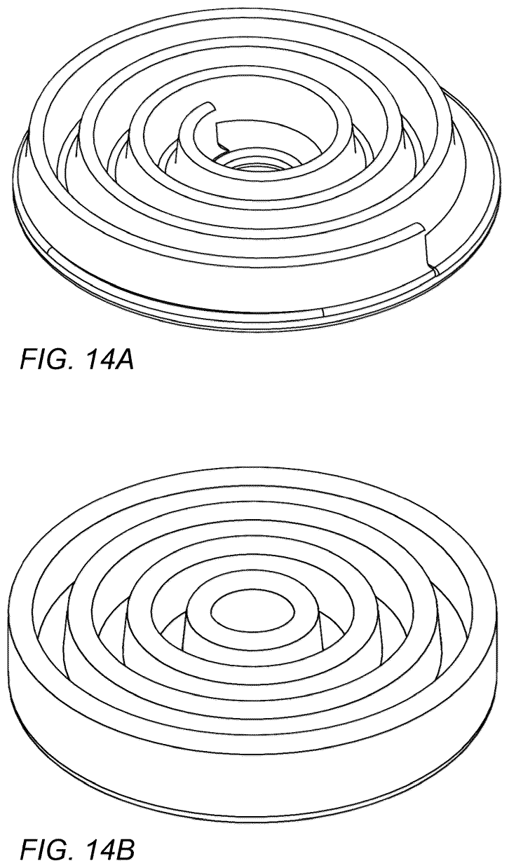

FIG. 14A depicts a spiral-shaped isolator rib structure that may be used in some embodiments, and can be mated with an identical spiral isolate of another component as a result of proper relative rotational orientation of the two spiral isolators.

FIG. 14B shows another example of a concentric circle rib structure for an isolator such as using the igniter of FIGS. 13A-H.

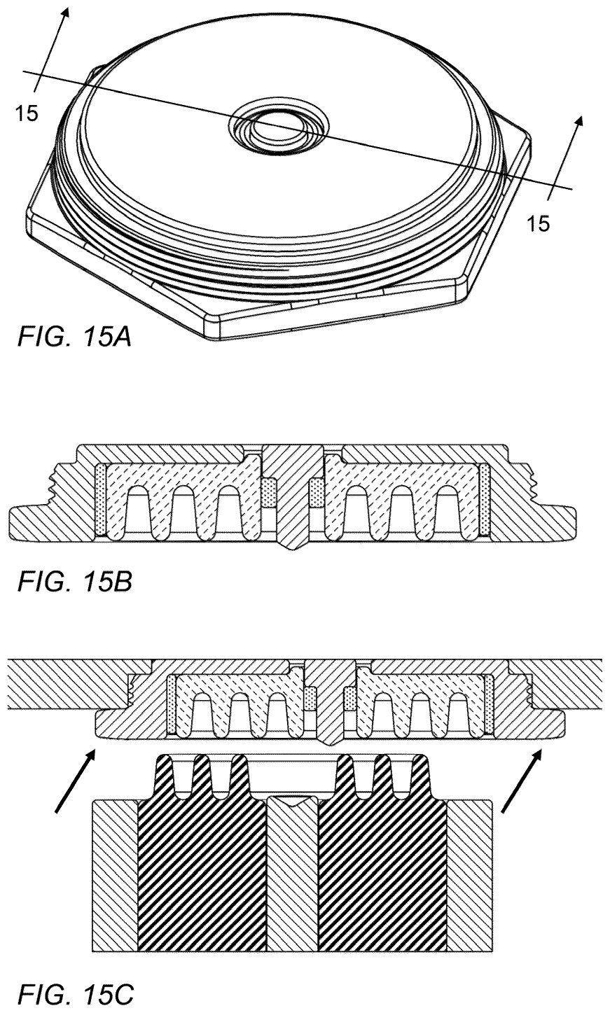

FIGS. 15A-15C show an igniter similar to that of FIGS. 13A-13H; however, this igniter does not include axial outer electrodes such that it is useful for typical spark ignition, but may not be suitable from traveling spark (TSI) applications where sustained, projected plasma is needed. This igniter is constructed similarly to that of FIGS. 13A-13H, but has a single, concentric outer electrode that has a large annular upper electrode surface that helps present a substantially continuous surface. The isolator separating the center electrode from the outer electrode is not flush with the igniter upper surface which helps promote sparking across the electrode gap. This recessed isolator approach may also be used in the TSI igniter design of FIGS. 13A-13H.

As indicated in FIG. 15C, this igniter may also be used with a ribbed ignition lead connector or other component to permit disconnection at an acute angle relative to the igniter's center axis.

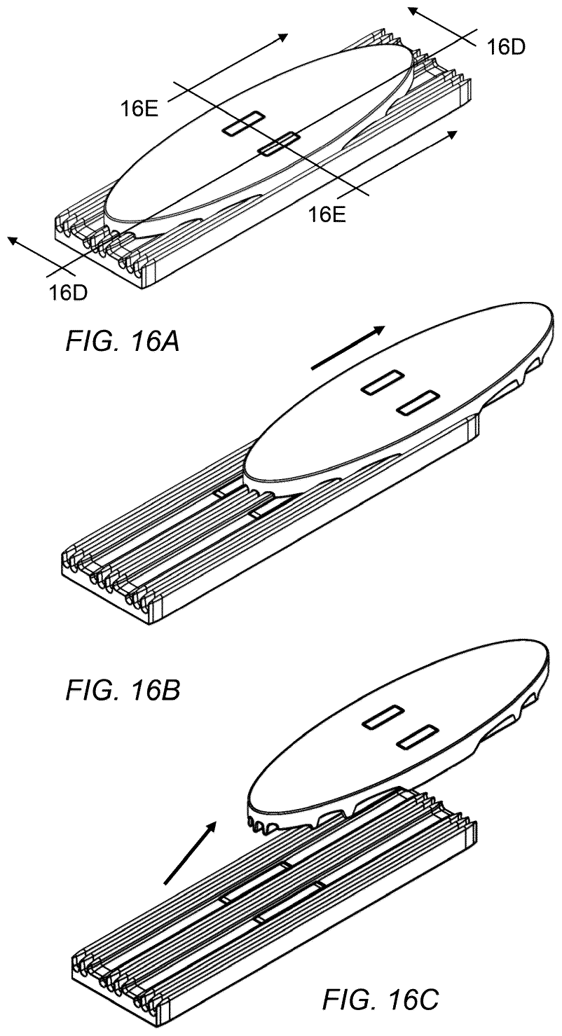

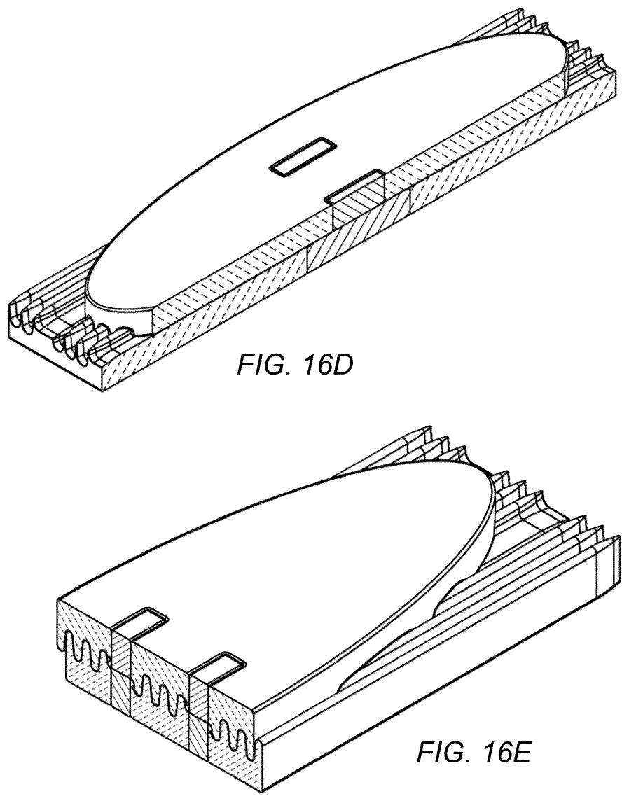

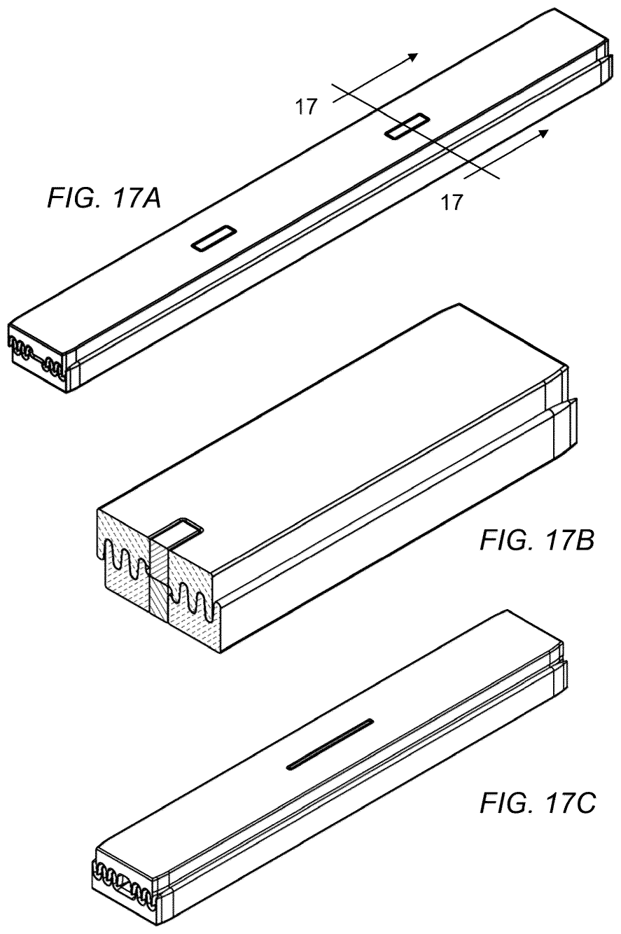

As opposed to purely or angularly axial separation as described above, a mostly or purely lateral/sliding disconnection may be used, as indicated by the various designs of FIGS. 16A-17C. These figures depict how Portions A and B from FIGS. 10A and 10B each have an electrode section (one with Polarity 1 and the other with Polarity 2) that can separate laterally. In each case a ribbed isolator is used to prevent shorting of the electrodes to each other or to external objects.

Having thus described several aspects of the present disclosure, it is to be appreciated that various alterations, modifications, and improvements will readily occur to those skilled in the art. Such alterations, modifications, and improvements are intended to be part of the present disclosure and are intended to be within the spirit and scope of the present disclosure. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

### Inventive Aspects

The following paragraphs are statements defining various aspects of the invention in claim format for present or future use as patent claims. These paragraphs represent at least some of the inventive aspects for which protection is sought.
1. A plasma generation system, comprising:
   a plasma generator, comprising:
   at least two electrodes each having a first end and a second end opposite the first end, the at least two electrodes extending substantially parallel to one another over a length from their first ends to their second ends; and
   an isolator spacing apart the at least two electrodes; and
   circuitry configured to:
   apply across the at least two electrodes, a breakdown voltage sufficient to induce breakdown between the at least two electrodes, resulting in formation of plasma in an initiation region that is along the length of the at least two electrodes; and
   apply, across the at least two electrodes, at least one subsequent pulse of electrical energy sufficient to propagate the plasma from the initiation region towards the first ends of the at least two electrodes,
   wherein a first electrode of the at least two electrode extends out of the isolator for a distance of no more than three times the edge-to-edge distance at the initiation region between the first electrode and a second electrode of the at least two electrodes; and
   wherein the at least two electrodes are configured below the initiation region for a distance equal to or greater than the edge-to-edge distance at the initiation region such that current from the at least one subsequent pulse of electrical energy flowing through the electrodes below the initiation region produces a Lorentz force acting upon the plasma.
2. The plasma generation system of inventive aspect 1, wherein the first electrode extends out of the isolator for a distance of no more than 2.25 times the edge-to-edge distance.
3. The plasma generation system of inventive aspect 1, wherein the first electrode extends out of the isolator for a distance of no more than 1.75 times the edge-to-edge distance.
4. The plasma generation system of inventive aspect 1, wherein the first electrode extends out of the isolator for a distance of less than 0.08 inches.
5. The plasma generation system of inventive aspect 1, wherein the first electrode extends out of the isolator for a distance of less than 0.04 inches.
6. The plasma generation system of inventive aspect 1, wherein the first end of the first electrode is flush with the isolator within a tolerance of +/−0.01 inches.
7. The plasma generation system of any one of the preceding inventive aspects, wherein at least one of the at least one subsequent pulse of electrical energy provides a current to the plasma generator of more than 450 Amps.
8. The plasma generation system of any one of the preceding inventive aspects, wherein at least one of the at least one subsequent pulse of electrical energy provides a current to the plasma generator of more than 600 Amps.
9. The plasma generation system of any one of the preceding inventive aspects, wherein at least one of the at least one subsequent pulse of electrical energy provides a current to the plasma generator of more than 1000 Amps.
10. The plasma generation system of any one of the preceding inventive aspects, wherein surfaces of the at least two electrodes that face one another are nearly parallel to one another over the length of the at least two electrodes.
11. The plasma generation system of any one of the preceding inventive aspects, wherein surfaces of the at least two electrodes that face one another are substantially parallel to one another over the length of the at least two electrodes.
12. The plasma generation system of any one of the preceding inventive aspects, wherein central axes of the at least two electrodes are substantially parallel to one another over the length of the at least two electrodes.
13. The plasma generation system of any one of the preceding inventive aspects, wherein the at least two electrodes are configured to support current flow in parallel directions, respectively, along the length.
14. The plasma generation system of any one of the preceding inventive aspects, wherein the initiation region comprises a portion of the isolator.
15. The plasma generation system of any one of the preceding inventive aspects, wherein the initiation region comprises a surface of the isolator.
16. The plasma generation system of inventive aspect 15, wherein the surface comprises a conductive treatment.
17. The plasma generation system of any one of the preceding inventive aspects, wherein the isolator comprises ceramic.
18. The plasma generation system of any one of the preceding inventive aspects, wherein the at least two electrodes are in a rail configuration in which central axes of the at least two electrodes are offset from one another in a plane that is transverse to a direction of the length.
19. The plasma generation system of any of the preceding inventive aspects, wherein the length of the at least two electrodes is a first length of a first electrode of the at least two electrodes, and a second electrode of the at least two electrodes has a second length that is different from the first length.
20. The plasma generation system of any of the preceding inventive aspects, wherein the at least two electrodes are in a concentric configuration in which the first electrode comprises a center electrode extending out of a central bore of the isolator, and the second electrode comprises an outer electrode extending substantially parallel to the first electrode.
21. The plasma generation system of inventive aspect 20, wherein the at least two electrodes further comprise third and fourth electrodes, wherein the third and fourth electrodes are spaced from the first electrode by the isolator and are connected electrically in the plasma generator to the second electrode, and wherein the second, third, and fourth electrodes are equally spaced around a perimeter of the isolator and comprise ground electrodes that together concentrically surround the first electrode.
22. The plasma generation system of inventive aspect 21, wherein second, third, and fourth electrodes are each located in an inset channel of the perimeter of the isolator.
23. The plasma generation system of any one of inventive aspects 1 to 19, wherein the at least two electrodes are in a coaxial configuration in which the first electrode comprises a center electrode extending out of a central bore of the isolator, and the second electrode comprises a single outer electrode that is concentric with the center electrode.
24. The plasma generation system of any one of the preceding inventive aspects, wherein the circuitry comprises:
   an inductance; and
   an energy storage device configured to apply the breakdown voltage and the at least one pulse of electrical energy across the at least two electrodes via the inductance.
25. The plasma generation system of inventive aspect 24, wherein:
   the inductance comprises a transformer having a saturable core;
   the energy storage device is configured to apply the breakdown voltage and the at least one pulse of electrical energy across the at least two electrodes via the transformer; and
   the transformer is configured to maintain saturation of the saturable core between application of the breakdown voltage and application of the at least one pulse of electrical energy.
26. The plasma generation system of inventive aspect 24 or 25, wherein the circuitry further comprises:
   a switching element coupled in a path from the at least two electrodes that includes the energy storage device and the inductance; and
   a controller configured to close the switching element to pass the at least one pulse of electrical energy from the energy storage device to the inductance for applying across the at least two electrodes.
27. A plasma generator comprising:
   an electrically-conductive first circuit connection piece and an electrically-conductive second circuit connection piece;
   an isolator;
   a first electrode and a second electrode, wherein the first and second electrodes are electrically insulated from each other by the isolator and are electrically connected, respectively, to the first and second circuit connection pieces;
   wherein the first and second electrodes each extend from a proximal tip to a distal tip and each have a firing portion and a mounting portion, each firing portion extending outwardly away from the isolator to the distal tip of the electrode, and each mounting portion extending inwardly from the firing portion to the proximal tip of the electrode, whereby a plasma can be formed in a plasma initiation region by application of a suitably high voltage across the first and second circuit connection pieces;
   wherein the first electrode extends out of the isolator for a distance of no more than three times the edge-to-edge distance at the initiation region between the first and second electrodes; and
   wherein the first electrode extends into the isolator for a distance sufficient to produce a Lorentz force acting upon the plasma in the plasma initiation region.
28. The plasma generation system of inventive aspect 27, wherein the first electrode extends out of the isolator for a distance of no more than two times the edge-to-edge distance.
29. The plasma generation system of inventive aspect 27, wherein the first electrode extends out of the isolator for a distance of less than 1.75 times the edge-to-edge distance.
30. The plasma generation system of inventive aspect 27, wherein the first electrode extends out of the isolator for a distance of less than 0.08 inches.
31 The plasma generation system of inventive aspect 27, wherein the first electrode extends out of the isolator for a distance of less than 0.04 inches.
32. The plasma generation system of inventive aspect 27, wherein the first end of the first electrode is flush with the isolator within a tolerance of +/−0.01 inches.
33. The plasma generation system of any one of the preceding inventive aspects, wherein surfaces of the first and second electrodes that face one another are nearly parallel to one another over the length of the electrodes.
34. The plasma generation system of any one of the preceding inventive aspects, wherein surfaces of the first and second electrodes that face one another are substantially parallel to one another over the length of the electrodes.
35. The plasma generation system of any one of the preceding inventive aspects, wherein central axes of the first and second electrodes are substantially parallel to one another over the length of the electrodes.
36. The plasma generation system of any one of the preceding inventive aspects, wherein the first and second electrodes are configured to support current flow in parallel directions, respectively, along the length.
37. The plasma generation system of any one of the preceding inventive aspects, wherein the initiation region comprises a portion of the isolator.
38. The plasma generation system of any one of the preceding inventive aspects, wherein the initiation region comprises a surface of the isolator.
39 The plasma generation system of inventive aspect 38, wherein the surface comprises a conductive treatment.
40. The plasma generation system of any one of the preceding inventive aspects, wherein the isolator comprises ceramic.
41. The plasma generation system of any one of the preceding inventive aspects, wherein the first and second electrodes are in a rail configuration in which central axes of the electrodes are offset from one another in a plane that is transverse to a direction of the length.
42. The plasma generation system of any of the preceding inventive aspects, wherein the firing portions of the first and second electrodes have different lengths.
43. The plasma generation system of any of the preceding inventive aspects, wherein the first comprises a center electrode extending out of a central bore of the isolator, and the second electrode comprises an outer electrode extending substantially parallel to the first electrode.
44. The plasma generation system of inventive aspect 43, wherein further comprising third and fourth electrodes, wherein the third and fourth electrodes are spaced from the first electrode by the isolator and are connected electrically in the plasma generator to the second electrode, and wherein the second, third, and fourth electrodes are equally spaced around a perimeter of the isolator and comprise ground electrodes that together concentrically surround the first electrode.
45. The plasma generation system of inventive aspect 44, wherein second, third, and fourth electrodes are each located in an inset channel of the perimeter of the isolator.
46. The plasma generation system of any one of inventive aspects 27 to 42, wherein the at least two electrodes are in a coaxial configuration in which the first electrode comprises a center electrode extending out of a central bore of the isolator, and the second electrode comprises a single outer electrode that is concentric with the center electrode.
47. The plasma generation system of any one of the preceding inventive aspects, wherein the circuitry comprises:
   an inductance; and
   an energy storage device configured to apply the breakdown voltage and the at least one pulse of electrical energy across the at least two electrodes via the inductance.
48. The plasma generation system of inventive aspect 47, wherein:
   the inductance comprises a transformer having a saturable core;
   the energy storage device is configured to apply the breakdown voltage and the at least one pulse of electrical energy across the at least two electrodes via the transformer; and
   the transformer is configured to maintain saturation of the saturable core between application of the breakdown voltage and application of the at least one pulse of electrical energy.
49. The plasma generation system of inventive aspect 47 or 48, wherein the circuitry further comprises:
   a switching element coupled in a path from the at least two electrodes that includes the energy storage device and the inductance; and
   a controller configured to close the switching element to pass the at least one pulse of electrical energy from the energy storage device to the inductance for applying across the at least two electrodes.
50.A plasma generation system for use in a main vehicle having a sub-vehicle that separates from the main vehicle in response to plasma generated by the plasma generation system, the plasma generation system comprising:
   a plasma generator; and
   circuitry configured to supply electrical pulses to the plasma generator sufficient to cause the plasma generator to form plasma, the circuitry being further configured to supply a plurality of the electrical pulses to the plasma generator;
   wherein a first portion of the plasma generation system is configured to be positioned at the sub-vehicle such that the plasma is formed in the presence of a depletable energy source that is ionizable or combustible by the plasma so as to generate thrust separating the sub-vehicle from the main vehicle; and
   wherein a second portion of the plasma generation system is mountable in the main vehicle, whereby at least the second portion of the plasma generation system remains with the main vehicle following the separating of the sub-vehicle from the main vehicle.
51. A plasma generation system for launching a sub-vehicle from a main vehicle, comprising:
   a plasma generator having a first electrode; and
   circuitry configured to apply electrical energy between the first electrode and a second electrode that is sufficient to form plasma between the first and second electrodes;
   wherein a first portion of the plasma generation system can be positioned at the sub-vehicle such that the plasma is formed in the presence of an energy source that is ionizable and/or combustible by the plasma so as to generate thrust separating the sub-vehicle from the main vehicle; and
   wherein a second portion of the plasma generation system is mountable in the main vehicle, whereby at least the second portion of the plasma generation system remains with the main vehicle following the separating of the sub-vehicle from the main vehicle.
52. The plasma generating system of inventive aspect 51, wherein the first portion of the plasma generation system is mountable to the main vehicle such that both portions of the plasma generation system remain with the main vehicle following the separating of the sub-vehicle from the main vehicle.
53. The plasma generating system of inventive aspect 51, wherein the first portion of the plasma generation system is mountable to the sub-vehicle such that, in response to the thrust, the first portion of the plasma generation system disconnects from the second portion of the plasma generation system and stays with the sub-vehicle.
54. A plasma generation system for use in a main vehicle having a sub-vehicle that separates from the main vehicle in response to plasma generated by the plasma generation system, the plasma generation system comprising:
   a plasma generator; and
   circuitry configured to supply electrical pulses to the plasma generator sufficient to cause the plasma generator to form plasma, the circuitry being further configured to supply a plurality of the electrical pulses to the plasma generator such that they form the plasma either as a plurality of individual sparks or as a traveling spark;
   wherein a firing end of the plasma generator is configured to be positioned in a reaction environment at the sub-vehicle such that the plasma is formed in the presence of a depletable energy source that is ionizable and/or combustible by the plasma so as to generate thrust separating the sub-vehicle from the main vehicle; and
   wherein at least a portion of the plasma generation system is mountable in the main vehicle, whereby at least the portion of the plasma generation system remains with the main vehicle following the separating of the sub-vehicle from the main vehicle.
55. The plasma generating system of inventive aspect 54, wherein the at least a portion of the plasma generation system comprises a first portion of the plasma generation system, and wherein the plasma generation system comprises a second portion that is mountable to the sub-vehicle such that, in response to the thrust, the second portion of the plasma generation system disconnects from the first portion of the plasma generation system and stays with the sub-vehicle.
56. An ignition system, comprising:
   an igniter, comprising:
      a first electrode; and
      an isolator spacing apart the first electrode from a second electrode when the igniter is installed in use with the first and second electrodes exposed to a reaction environment; and
   circuitry configured to apply electrical energy between the first and second electrodes to generate a spark between the electrodes to initiate a reaction in the reaction environment;
   wherein a portion of the ignition system is configured to disconnect from a remaining portion of the ignition system following initiation of the reaction.
57. The ignition system of inventive aspect 56, wherein the second electrode comprises a separate electrode that is not part of the igniter.
58. The ignition system of inventive aspect 56, wherein the igniter further comprises the second electrode, whereby the igniter has two or more electrodes.
59. The ignition system of inventive aspect 56, wherein the portion of the ignition system that disconnects comprises a portion of the igniter, whereby the remaining portion of the ignition system comprises the circuitry and a remaining portion of the igniter that is connected to the circuitry.
60. The ignition system of inventive aspect 59, wherein the portion of the igniter that disconnects includes a firing end of the igniter include at least a portion of the first electrode.
61. The ignition system of inventive aspect 56, wherein the portion of the ignition system that disconnects comprises the igniter, whereby the remaining portion of the ignition system comprises the circuitry.
62. The ignition system of inventive aspect 61, wherein the circuitry comprises an exciter and an ignition lead that connects an output of the exciter to the igniter.
63. The ignition system of inventive aspect 62, wherein the ignition lead connects to the igniter using an ARP670-type connector that includes a slip connection of conductors that permits separation of the ignition lead from the igniter solely by application of an axial separating force.
64. The ignition system of inventive aspect 56, wherein the portion of the ignition system comprises a disconnecting portion that disconnects from the remaining portion in a disconnection direction that immediately separates the disconnecting portion from contact with the remaining portion.
65. The ignition system of inventive aspect 56, wherein the portion of the ignition system comprises a disconnecting portion that disconnects from the remaining portion by sliding along a surface of the remaining portion for a distance.
66. The ignition system of inventive aspect 65, wherein the distance is determined by one or more dimensions of the isolator.
67. The ignition system of inventive aspect 56, wherein the circuitry generates the spark in response to a firing signal received at an input of the circuitry.
68. The ignition system of inventive aspect 67, wherein the circuitry is configured to, following the spark, generate one or more additional sparks between the first and second electrodes.
69. The ignition system of inventive aspect 68, wherein the circuitry continues to generate the sparks until the portion of the ignition system disconnects from the remaining portion of the ignition system.
70. An ignition system for an aerospace vehicle having a main vehicle and a sub-vehicle that separates from the main vehicle during flight by ignition of a fuel source in the sub-vehicle, the ignition system comprising:
   an igniter having a first electrode and an isolator spacing apart the first electrode from a second electrode when the igniter is installed in use; and
   circuitry configured to apply electrical energy between the first and second electrodes to generate a spark between the electrodes;
   wherein a portion of the ignition system is configured to disconnect from a remaining portion of the ignition system following initiation of the reaction.
71. A plasma generation system, comprising:
   a plasma generator, comprising:
      at least two electrodes; and
      an isolator spacing apart the at least two electrodes; and
   circuitry configured to apply electrical energy across the at least two electrodes to form, sustain, and/or propagate plasma between the at least two electrodes,
   wherein the plasma generator and the circuitry are configured to automatically disconnect from one another following application of the electrical energy.
72. The plasma generation system of inventive aspect 71, wherein the circuitry is configured to apply across the at least two electrodes, a breakdown voltage sufficient to induce breakdown between the at least two electrodes, resulting in formation of the plasma in an initiation region.
73. The plasma generation system of inventive aspect 72, wherein:
   the circuitry is configured to apply, across the at least two electrodes, at least one pulse of electrical energy sufficient to propagate the plasma from the initiation region toward a distal tip of the at least two electrodes; and
   the plasma generator and the circuitry are configured to automatically disconnect from one another following application of the at least one pulse of electrical energy.
74. the plasma generation system of inventive aspect 73, wherein the circuitry comprises:
   an inductance; and
   an energy storage device configured to apply the breakdown voltage and the at least one pulse of electrical energy across the at least two electrodes via the inductance.
75. The plasma generation system of inventive aspect 74, wherein:
   the inductance comprises a transformer having a saturable core;
   the energy storage device is configured to apply the breakdown voltage and the at least one pulse of electrical energy across the at least two electrodes via the transformer; and
   the transformer is configured to maintain saturation of the saturable core between application of the breakdown voltage and application of the at least one pulse of electrical energy.
   76. The plasma generation system of inventive aspect 74 or 75, wherein the circuitry further comprises:
   a switching element coupled in a path from the at least two electrodes that includes the energy storage device and the inductance; and
   a controller configured to close the switching element to pass the at least one pulse of electrical energy from the energy storage device to the inductance for applying across the at least two electrodes.
77. The plasma generation system of any one of inventive aspects 71 to 76, wherein, prior to breakdown, an impedance between the at least two electrodes in the initiation region is a lowest impedance between the at least two electrodes.
78. The plasma generation system of inventive aspect 77, wherein the initiation region comprises a portion of the isolator.
79. The plasma generation system of inventive aspect 78, wherein the initiation region comprises a surface of the isolator.
80. The plasma generation system of inventive aspect 79, wherein the surface comprises a conductive treatment.
81. The plasma generation system of any one of inventive aspects 71 to 80, wherein the isolator comprises ceramic.
82. The plasma generation system of any one of inventive aspects 71 to 81, wherein the at least two electrodes are in a coaxial configuration in which a first electrode of the at least two electrodes is configured as a center electrode and a second electrode of the at least two electrodes is configured as an outer electrode that is concentric with the center electrode.
83. The plasma generation system of any one of inventive aspects 71 to 82, wherein the at least two electrodes are in a rail configuration in which central axes of the at least two electrodes are offset from one another in a plane that is transverse to the central axes.
84. The plasma generation system of any one of inventive aspects 71 to 83, wherein the circuitry is configured to automatically physically separate from the plasma generator following application of the electrical energy.
85. The plasma generation system of any one of inventive aspects 71 to 84, wherein the circuitry is configured to automatically disconnect from the plasma generator using force subsequent at least partial ignition of an air-fuel mixture caused by the plasma.
86. The plasma generation system of any one of inventive aspects 71 to 85, wherein the isolator of the plasma generator comprises at least one ridge configured to permit disconnection of the plasma generator from the circuitry following application of the electrical energy.
87. The plasma generation system of inventive aspect 86, wherein the at least one ridge comprises a plurality of ridges positioned in series along a width that is transverse to a length of the at least two electrodes.
88. The plasma generation system of inventive aspect 86, wherein the at least one ridge comprises a plurality of ridges positioned concentrically in a plane that is transverse to a length of the at least two electrodes.
89. The plasma generation system of inventive aspect 86, wherein the at least one ridge spirals in a plane that is transverse to a length of the at least two electrodes.
90. The plasma generation system of any one of inventive aspects 86 to 89, wherein the at least one ridge is configured to compress and/or to compress at least one ridge of the circuitry from automatically disconnecting from the circuitry.
91. The plasma generation system of inventive aspect 90, wherein the at least one ridge is configured to compress so as to reduce differences in height between the at least one ridge and regions of the isolator that surrounds and/or are between the at least one ridge.
92. The plasma generation system of any one of inventive aspects 86 to 89, wherein the at least one ridge is configured to flatten and/or to flatten at least one ridge of the circuitry from automatically disconnecting from the circuitry.
93. The plasma generation system of any one of inventive aspects 86 to 92, wherein the at least one ridge is configured to, prior to disconnection, provide an impedance between the at least two electrodes that is greater than in an initiation region in which plasma is formed between the at least two electrodes.
94 The plasma generation system of inventive aspect 93, wherein the at least one ridge comprises surfaces that contribute to the impedance being greater than in the initiation region.
95. The plasma generation system of any one of inventive aspects 86 to 94, wherein the at least one ridge comprises a different material from at least one ridge of the circuitry from which the at least one ridge of the isolator is configured to automatically disconnect.
96. The plasma generation system of any one of inventive aspects 86 to 95, wherein the at least one ridge is configured to yield to and/or flatten at least one ridge of the circuitry from which the at least one ridge of the isolator is configured to automatically disconnect.
97. The plasma generation system of any one of inventive aspects 71 to 96, wherein the plasma generator comprises a surface configured to project plasma into a combustion region in a configuration in which the surface is substantially flush with an interfacing surface of the combustion region.
98. The plasma generation system of any one of inventive aspects 71 to 97, wherein the at least two electrodes have a cross-section selected from a group consisting of: rectangular, square, elliptical, and circular.
99. The plasma generation system of any one of inventive aspects 56 to 98, wherein the isolator has a cross-section selected from a group consisting of: rectangular, square, elliptical, and circular.
100. The plasma generation system of any one of inventive aspects 86 to 99, wherein the plasma generator is configured to project plasma into a combustion region and, following the disconnect, the circuitry is configured to secure to the combustion region or physically separate from the combustion region.
101. The plasma generation system of any one of inventive aspects 71 to 100, wherein a portion of the plasma generator is exposed as a result of automatically disconnecting from the circuitry, and the plasma generation system further comprises a member configured to cover the portion of the plasma generator once exposed.
102. A plasma generator, comprising:
   an igniter, comprising:
      a first electrode;
      a second electrode; and
      an isolator spacing apart the first electrode and the second electrode;
   wherein the electrodes have a length L comprising an exposed first portion of length L1 and an embedded second portion of length L2, wherein the ratio of L1:L2 is in the range of 1:3 to 1:100.
103.The plasma generator of inventive aspect 102, wherein the ratio of L1:L2 is at least 1:5.
104. The plasma generator of inventive aspect 102, wherein the ratio of L1:L2 is at least 1:10.

1. A plasma generation system, comprising:
a plasma generator, comprising:
at least two electrodes each having a first end and a second end opposite the first end, the at least two electrodes extending nearly parallel to one another over a length from their first ends to their second ends; and
an isolator spacing apart the at least two electrodes; and
circuitry configured to:
apply across the at least two electrodes, a breakdown voltage sufficient to induce breakdown between the at least two electrodes, resulting in formation of plasma in an initiation region that is along the length of the at least two electrodes; and
apply, across the at least two electrodes, at least one subsequent pulse of electrical energy sufficient to propagate the plasma from the initiation region towards the first ends of the at least two electrodes,
wherein a first electrode of the at least two electrode extends out of the isolator for a distance of no more than three times the edge-to-edge distance at the initiation region between the first electrode and a second electrode of the at least two electrodes; and
wherein the at least two electrodes are configured below the initiation region for a distance equal to or greater than the edge-to-edge distance at the initiation region such that current from the at least one subsequent pulse of electrical energy flowing through the electrodes below the initiation region produces a Lorentz force acting upon the plasma.

2. The plasma generation system of claim 1, wherein the first electrode extends out of the isolator for a distance of no more than two times the edge-to-edge distance.

3. The plasma generation system of claim 1, wherein the first electrode extends out of the isolator for a distance of no more than the edge-to-edge distance.

4. The plasma generation system of claim 1, wherein the first electrode extends out of the isolator for a distance of less than 0.08 inches.

5. The plasma generation system of claim 1, wherein the first electrode extends out of the isolator for a distance of less than 0.04 inches.

6. The plasma generation system of claim 1, wherein the first end of the first electrode is flush with the isolator within a tolerance of +/−0.01 inches.

7. The plasma generation system of claim 1, wherein at least one of the at least one subsequent pulse of electrical energy provides a current to the plasma generator of more than 450 Amps.

8. The plasma generation system of claim 1, wherein at least one of the at least one subsequent pulse of electrical energy provides a current to the plasma generator of more than 600 Amps.

9. The plasma generation system of claim 1, wherein at least one of the at least one subsequent pulse of electrical energy provides a current to the plasma generator of more than 1000 Amps.

10. The plasma generation system of claim 1, wherein the at least two electrodes extend substantially parallel to one another over a length from their first ends to their second ends.

11. The plasma generation system of claim 1, wherein the initiation region comprises a portion of the isolator.

12. A plasma generation system, comprising:
a plasma generator, comprising:
first and second electrodes each extending for a length from an exposed distal end to a proximal end, each of the first and second electrodes extending along an electrode axis that is nearly parallel to the electrode axis of the other electrode for a length from the distal end towards the proximal end of the electrode; and
an isolator spacing the electrodes apart; and
circuitry configured to:
apply across the first and second electrodes, a breakdown voltage sufficient to induce breakdown between the electrodes, resulting in formation of plasma in an initiation region that is along the length of the electrodes; and
apply, across the electrodes, at least one subsequent pulse of electrical energy sufficient to propagate the plasma from the initiation region in a direction away from the isolator,
wherein the at least one subsequent pulse of electrical energy includes a current flow through the electrodes sufficient to move the plasma to the distal ends and subsequently beyond the distal ends of the electrodes and to form virtual electrodes comprising electrical current flowing out of the distal end of one of the electrodes and through a portion of the plasma in a direction substantially parallel to the one electrode's axis and flowing into the distal end of an other of the electrodes through another portion of the plasma in a direction substantially parallel to the other electrode's axis, with a portion of the plasma extending between the virtual electrodes for conduction of the current from one virtual electrode to the other virtual electrode.

13. The plasma generation system of claim 12, wherein the first electrode extends out of the isolator for a distance of less than 0.08 inches.

14. The plasma generation system of claim 12, wherein the first electrode extends out of the isolator for a distance of less than 0.04 inches.

15. The plasma generation system of claim 12, wherein the first end of the first electrode is flush with the isolator within a tolerance of +/−0.01 inches.

16. The plasma generation system of claim 12, wherein the current flow is more than 450 Amps.

17. The plasma generation system of claim 12, wherein the current flow is more than 600 Amps.

18. The plasma generation system of claim 12, wherein the current flow is more than 1000 Amps.

19. The plasma generation system of claim 12, wherein the electrode axes of the first and second electrodes are substantially parallel.

20. The plasma generation system of claim 12, wherein the circuit is configured to supply the current flow at an amperage and length of time such that the virtual electrodes extend beyond the distal ends of the electrodes by a length sufficient to create a Lorentz force from the current flowing through the virtual electrodes.

21. The plasma generation system of claim 20, wherein the Lorentz force from the current flowing through the virtual electrodes is sufficient to move outwardly away from the distal ends the portion of the plasma extending between the virtual electrodes.

22. A method of creating a traveling spark, comprising:
forming a plasma from an ionizable medium by causing electrons to flow between a pair of spaced electrodes in the presence of the ionizable medium, wherein the electrodes each extend along an axis nearly parallel to each other, wherein the plasma is formed in a plasma initiation region between the electrodes, and wherein, at formation of the plasma, the electrons are emitted by one of the electrodes and received by the other of the electrodes in a direction substantially perpendicular to the electrode axes;
moving the plasma along the electrodes to distal tips of the electrodes by applying at least one subsequent current pulse to the electrodes before recombination of the plasma; and
moving the plasma beyond the distal tips using virtual electrodes that extend axially past the distal tips of the electrodes, wherein the virtual electrodes comprise electrons flowing out of the distal tip of one of the electrodes in a direction nearly parallel to the electrode's axis, through the plasma between the virtual electrodes, and into the other electrode in a direction nearly parallel to the other electrode's axis.

23. The method set forth in claim 22, wherein the electrodes'axes are substantially parallel to each other.

24. The method set forth in claim 22, wherein the electrodes'axes are within 5° of being parallel to each other.

25. A plasma generation system comprising plasma generating circuitry and a plasma generator, wherein the circuitry is configured to produce repeated pulses of plasma via the plasma generator, and wherein at least one portion of the plasma generation system can be automatically physically separated from one or more other portions of the plasma generation system, wherein the at least one portion includes the plasma generator or a portion thereof, and wherein the separation prevents the generation of subsequent pulses of plasma from the plasma generator.

26. The plasma generation system of claim 25, wherein the at least one portion comprises the plasma generator.

27. The plasma generation system of claim 26, wherein the plasma generator comprises an igniter having a housing, first and second electrodes, and an isolator, wherein the electrodes and isolator are mounted in the housing with the electrodes being electrically isolated from one another by the isolator, wherein the housing has a circular perimeter portion comprising threads for mounting the igniter at a combustion chamber so that the electrodes are exposed to a reaction environment within the chamber.

28. The plasma generation system of claim 27, wherein the igniter has a central axis defining an axial direction and wherein the igniter has an axial length in the axial direction that is no more than two inches.

29. The plasma generation system of claim 27, wherein the axial length is no more than one inch.

30. The plasma generation system of claim 27, wherein the first and second electrodes have a length in the axial direction sufficient to generate a Lorentz force that moves a plasma formed between the electrodes outwardly from distal ends of the electrodes.

31. The plasma generation system of claim 30, wherein the length of the electrodes is sufficient to move the plasma with a current through the electrodes and plasma of at least 450 Amps.

32. The plasma generation system of claim 30, wherein the length of the electrodes is sufficient to move the plasma with a current through the electrodes and plasma of at least 600 Amps.

32. (canceled)

33. The plasma generation system of claim 26, wherein the plasma generator comprises an igniter having a housing, first and second electrodes, and an isolator, wherein the electrodes and isolator are mounted in the housing with the electrodes being electrically isolated from one another by the isolator, wherein the igniter includes a firing end having the first and second electrodes exposed for generating a plasma between the electrodes, the igniter further including a connecting end for connection to an ignition lead, wherein the isolator extends through the igniter and terminates at the connecting end with a ribbed insulator surface extending between the first and second electrodes to thereby define a surface path over the ribbed surface that is longer than the direct distance between the first and second electrodes.

34. The plasma generation system of claim 33, further comprising the ignition lead having a ribbed insulator and first and second conductors, wherein the ribbed insulator mates with the ribbed surface of the isolator when the ignition lead is connected to the igniter with the first and second electrodes electrically connected to the first and second conductors, respectively.

35. The plasma generation system of claim 25, wherein the plasma generator comprises circuitry configured to supply electrical pulses to the plasma generator sufficient to cause the plasma generator to form plasma, the circuitry being further configured to supply a plurality of the electrical pulses to the plasma generator;
wherein the at least one portion of the plasma generation system is configured to be positioned at the sub-vehicle such that the plasma is formed in the presence of a depletable energy source that is ionizable or combustible by the plasma so as to generate thrust separating the sub-vehicle from the main vehicle; and
wherein the one or more other portions of the plasma generation system are mountable in the main vehicle, whereby at least the one or more other portions of the plasma generation system remains with the main vehicle following the separating of the sub-vehicle from the main vehicle.

36. A plasma generation system, comprising:
a plasma generator having a first electrode; and
circuitry configured to apply electrical energy between the first electrode and a second electrode that is sufficient to form plasma between the first and second electrodes;
wherein a first portion of the plasma generation system automatically disconnects from a remaining portion of the plasma generation system.

37. The plasma generation system of claim 36, further comprising the second electrode, a housing, and an isolator, wherein the first and second electrodes and isolator are mounted in the housing with the isolator electrically isolating the first and second electrodes, wherein the first portion comprises the plasma generator.
